(19) United States
(12) Patent Application Publication
(10) Pub. No.: US 2008/0215167 A1
(43) Pub. Date: Sep. 4, 2008

(54) Feed delivery system for enhancing ruminant animal nutrition

(76) Inventor: James F. Beck, Rogers, MN (US)

Correspondence Address: Moss & Barnett P.A., 4800 Wells Fargo Center, 90 South Seventh Street, Minneapolis, MN, 55402-4129, US

(21) Appl. No.: 11/881,483

(22) Filed: Jul. 27, 2007

Related U.S. Application Data
(63) Continuation-in-part of application No. 11/494,312, filed on Jul. 27, 2006.

(51) Int. Cl. G06F 17/00

(52) U.S. Cl. 700/90

(57) ABSTRACT

A feed delivery system for a dairy farm wherein a third-party supplier of the system can provide the dairy farm with lists of approved hybrids for the feed components, necessary information inputs for practicing the feed method, and all or a portion of its component needs for the feed ration corresponding to a feed ration that contains: at least one primary forge source selected from the group consisting of brown midrib corn silage, dual-purpose corn silage, leafy corn silage, and grass silage; a secondary forage source selected from the group consisting of dual-purpose corn silage, alfalfa haylage, alfalfa dry hay, grass silage, and alfalfa/grass mix; a corn grain of floury and/or vitreous endosperm starch grain into which normal dent corn or mutt corn may be blended in order to achieve a predetermined level of in vitro starch digestibility; such grain component being further processed to produce a specific particle size of the blended starch. The feed delivery system can also provide the dairy farm with real-time characterizations of at least some of its feed ingredients, and re-penning strategies for maximizing the milk productivity of the cows.

### CROSS-REFERENCE TO RELATED APPLICATION

This application is a continuation-in-part of U.S. Ser. No. 11/494,312 filed on Jul. 27, 2006, which is hereby incorporated by reference in its entirety.

### FIELD OF THE INVENTION

This invention relates to nutrition of the ruminant animal, and more specifically to a system delivering feed ingredients and informational inputs to a dairy farm for enabling a method for enhancing feed rations for dairy cows in order to maximize their net production of milk, peak milk yield, and stability of milk production throughout the cow's lactation cycle.

### BACKGROUND OF THE INVENTION

Milk provides the primary source of nutrition for newborns before they are capable of digesting more diverse foods. At the same time, milk sourced from commercial sources like dairy cows can provide nutritional benefits to humans long after their very early infancy. Dairy cows produce their milk in accordance with the natural dictates of a lactation cycle. Good sources of dietary energy are critical during high-milk production periods of this lactation cycle, and protein is particularly important during the ramp up leading to the cow's peak of milk production. Supplemental means have been employed by dairy farmers to increase milk production. For instance, Monsanto Company has sold since 1994 with FDA approval recombinant bovine somatotropin. This “bST” hormone is administered to the cows to enhance their milk production during the lactation phase. Enhancing the nutritional status of the cows will also increase milk production, and may allow a greater response to bST hormone administrated as well.

Another approach for enhancing milk production has entailed use in feed rations of corn silage produced from a hybrid plant that is homozygous to a brown midrib bm3 gene. See U.S. Pat. Nos. 5,767,080; 5,859,353; 5,969,222; 5,977,458; and 6,114,609 issued to Beck et al. However, the higher fiber digestibility level (NDFd) of the BMR corn silage has also been shown to cause excessive rates of feed passage through the cow's rumen, compared with the required rumen residence time for the rumen microbial population to digest the feed into the desirable combination of volatile fatty acids (VFAs). This can cause excessive production of VFAs in the dairy cow's rumen, particularly propionate, if the feed ration is not properly balanced and fed to the correct stage of production of the dairy cow, thereby reducing the buffering capacity (lower physically effective neutral detergent fiber (“peNDF”)) of the total diet and leading to acidosis and other metabolic problems in the cow. Moreover, such “BMR” corn hybrids have also exhibited a yield reduction which can discourage their planting by farmers concerned about undesirable agronomics and forage yield at harvest, particularly if the net yield drag is perceived to surpass the milk production gain when the resulting BMR corn silage is fed to a dairy cow.

Feed ration costs account for 45-60% of the total cost of producing milk, so optimal nutrition is important. Ideally, appropriate nutrient levels should be maintained, while feed costs are carefully maintained. Such optimal nutrition will enhance milk production, improve overall health of the cow, and reduce associated costs like veterinary bills, drug treatments, and breeding.

The main nutrient categories of importance for dairy cow rations are carbohydrates, fats, proteins, minerals, vitamins, and water. While fiber is not strictly a nutrient by definition, it critically affects the cow's digestion, and therefore must be considered by the dairy farmer or nutritionist when formulating feed rations. The undigested feed and digesta from the reticulum pass to the rumen, which essentially acts as a large fermentation vat. Holding 40 to 60 gallons of material, it also contains an estimated 150 billion bacteria, protozoa, and fungi per teaspoon of content. If fed a proper balance of forages and grain, the resulting 5.8-6.4 pH and 100-108° F. conditions within the rumen should allow the growth of these important microorganisms.

Through a process of rumination, the cow reduces the particle size of feed in the rumen, which enhances microbial function, and allows for easier passage out of the stomach compartments. Due to its strong musculature, the rumen allows mixing and churning of the digesta.

The objective of feeding dairy cows nutritionally balanced diets is to provide a rumen environment that maximizes microbial production and growth. The microbial population within the rumen consists of bacteria, protozoa, and fungi. Rumen pH is one of the most variable factors which can influence this microbial population and the levels of volatile fatty acids produced. The fiber digesters are most active at pH=6.2-6.8. Cellulolytic bacteria and methanogenic bacteria can be reduced when the pH begins to fall below 6.0. The starch digester microbes prefer a more acidic environment with a pH=5.2-6.0. Certain species of protozoa can be greatly depressed with a pH below 5.5. To accommodate all of these needs, normal feeding practices should be maintained at pH=5.8-6.4.

Within the rumen, these microorganisms can digest carbohydrates, proteins, and fiber. Through this digestion process, volatile fatty acids (“VFA”) and microbial protein that can be utilized by the animal are produced. Both structural (NDF) and non-structural (sugar and starches) carbohydrates undergo microbial fermentation in the rumen to produce VFA like acetic, propionic, butyric, isobutyric, valeric and isovaleric acids, and traces of various other acids. Acetic acid can constitute 50-60% of the total VFA and predominate in a high-forage diet. Production of adequate levels of acetate in the rumen is essential to maintain adequate levels of milk fat. Meanwhile, propionic acid can make up 18-20% of the total VFA and reaches its highest concentration in high-grain diets. Propionic acid provides energy through conversion to blood glucose in the liver, and is employed in milk lactose or milk sugar synthesis. The rumen microbes also act to synthesize microbial protein from crude protein in the feed rations to produce amino acids. The amino acids in turn produce milk protein.

The dairy farmer or animal nutritionist today has a variety of different components to choose from for purposes of feeding dairy cows. Perhaps, the most traditional diet is grass that can be readily obtained by permitting the cows to graze on pastureland. Such a feed source is relatively inexpensive and convenient for feed purposes. However, it may also be naturally unavailable during winter months when grass is dormant in many regions where cows are raised. Moreover, unsupplemented grass pastures do not contain sufficient digestible nutrients to support high levels of milk production. Indeed, a dairy cow fed on grass alone will typically produce only 40 pounds of milk per day.

Dry hay constitutes grass that has been chopped for length and partially dried to reduce its moisture level. Dry hay may be fed to the cow throughout the year. It may be used to control rumen motility and prompt cud chewing. However, it suffers from the same relatively low energy level as its grass precursor, producing only 40 pounds of milk per day for a cow fed primarily on hay.

At the other end of the energy spectrum is grain, such as corn grain. High in carbohydrates and protein, grain is good for increasing milk production in dairy cows. But, if a dairy cow is fed nothing but grain, it will produce an unnaturally high volume of lactic acid and proprionic acid in the rumen. Absorption of large amounts of these two acids across the rumen wall to the blood produces system acidosis in the cow. The rumen pH decreases to a very acidic level of less than 5.5. This results in the cow going off feeds which will lead to low milk production levels in the near term, displaced abomasums and possible death if untreated in the longer term, and high veterinary bills in the meantime.

Considerable dairy research has been devoted to the scientific study of use of forage components in dairy cow diets. Comprising a harvested crop plant like corn or alfalfa that has been chopped to length and then ensiled to partially ferment, such forage sources provide effective fiber to the cow's diet, and the NDF in the forage prompts cud chewing by the cow that leads to salivation. Forage also enhanced rumen “motility”—the time period required for the feed constituents to pass through the gastrointestinal tract and be digested sufficiently for the nutrients to be absorbed across the rumen and small intestinal wall. M. Oba & M. S. Allen, “Effects of Brown Midrib 3 Mutation in Corn Silage on Dry Matter Intake and Productivity in High Yielding Cows,” J. Dairy Sci. 85:135-42 (1999) summarized research that compared cow response to high or lower forage NDF digestibility, and found that greater forage digestibility (“NDFd”) was associated with increased dry matter intake (“DMI”) and milk yield. If one assumed a linear response, then for each unit increase in NDFd, there was a 0.17 kg increase in DMI, and a 0.25 kg increase in 4% fat-corrected milk yield.

Other studies have shown that higher milk-producing cows respond better to corn silage with improved NDFd levels than do lower producing cows. Oba & Allen (1999); S. K. Ivan, R. J. Grant, D. Weakley, and J. Beck, “Comparison of a Corn Silage Hybrid with High Cell-Wall Content and Digestibility with a Hybrid of Lower Cell-Wall Content On Performance of Holstein Cows,” J. Dairy Sci. 88:244-54 (2005). These studies demonstrate the usefulness of allocating forage based upon NDFd to various production groups of cows.

A number of research papers have evaluated cow response to three different categories of corn silage: dual-purpose corn, leafy corn, and brown midrib corn (“BMR”). Interactions of hybrid, maturity and processing of the different corn types were studied within L. M. Johnson, J. H. Harrison, D. Davidson, J. L. Robutti, M. Swift, W. C. Mahanna, and K. Shinners, “Corn Silage Management I: Effects of Hybrid Maturity and Mechanical Processing on Chemical and Physical Characteristics,” J. Dairy Sci. 85:833-53 (2002); L. M. Johnson, J. H. Harrison, D. Davidson, M. Swift, W. C. Mahanna, and K. Shinners, “Corn Silage Management II: Effects of Hybrid, Maturity and Mechanical Processing on Digestion and Energy Content,” J. Dairy Sci. 85: 2913-27 (2002); L. M. Johnson, J. H. Harrison, D. Davidson, M. Swift, W. C. Mahanna, and K. Shinners, “Corn Silage Management III: Effects of Hybrid Maturity, and Processing on Nitrogen Metabolism and Mineral Fermentation,” J. Dairy Sci. 85: 2928-47 (2002); L. M. Johnson, J. H. Harrison, D. Davidson, W. C. Mahanna, and K. Shinners, “Corn Silage Management: Effects of Hybrid, Chop Length, and Mechanical Processing on Digestion and Energy Content,” J. Dairy Sci. 86: 208-31 (2003); L. M. Johnson, J. H. Harrison, D. Davidson, C. Hunt, W. C. Mahanna and K. Shinners, “Corn Silage Management: Effects of Hybrid, Maturity, Chop Length, and Mechanical Processing on Rate and Extent of Digestion,” J. Dairy Sci. 86: 3271-99 (2003).

Research studies comparing the nutritional performance of dual-purpose corn silage and leafy corn silage have shown mixed results, a positive response in one case, and no response by leafy hybrids in the other study. C. S. Ballard, E. D. Thomas, D. S. Tsang, P. Mandebvu, C. J. Sniffen, M. I. Endres, and M. D. Carter, “Effect of Corn Silage on Dry Matter Yield, Nutrient Composition, In-Vitro Digestion, Intake by Dairy Heifers, and Milk Production By Dairy Cows,” J. Dairy Sci. 84: 442-52 (2001); E. D. Thomas, P. Mandebvu, C. S. Ballard, C. J. Sniffen, M. P. Carter, and J. Beck, “Comparison of Corn Silage Hybrids for Yield, Nutrient Composition, In-Vitro Digestibility, and Milk Yield by Dairy Cows,” J. Dairy Sci. 84: 2217-26 (2001).

Another research study directly compared a leafy corn hybrid, a BMR corn hybrid, and two dual-purpose corn hybrids. D. J. R. Cherney, J. H. Cherney, L. E. Chase, and W. J. Cox, “Milk Production in High-Producing Dairy Cows as Influenced by Corn Silage Quality,” Prof. Animal Scientist 20: 302-11 (2004). This research demonstrated that use of BMR and leafy hybrid silage resulted in greater dry matter intake for dairy cows than the dual-purpose corn hybrids, and that the BMR and leafy corn hybrids also had similar, higher milk yields compared with the dual-purpose corn hybrids. There was variability in the productive response for cows fed the leafy corn silage, but the BMR corn hybrid clearly achieved greater dry matter intake, and usually milk yield compared with the dual-purpose corn hybrids. Other research studies, however, showed no benefit of leafy corn silage over dual-purpose silage. See Thomas, et al. (2001). The greater NDFd content of BMR corn hybrids versus dual-purpose corn hybrids has been evaluated, recognizing that BMR corn silage provides an excellent source of digestible NDF, but with a significant 10-15% yield reduction for the farmer. See Oba & Allen (1999); M. Oba & M. S. Allen, “Effects of Brown Midrib 3 Mutations in Corn Silage on Productivity of Dairy Cows Fed Two Concentrations of Dietary Neutral Detergent Fiber: #1. Feeding Behavior and Nutrient Utilization,” J. Dairy Sci. 83:1333-41 (2000); M. Oba & M. S. Allen, “Effects of Brown Midrib 3 Mutations in Corn Silage on Productivity of Dairy Cows Fed Two Concentrations of Dietary Neutral Detergent Fiber: #2. Chewing Activities,” J. Dairy Sci. 83:1342-49 (2000); M. Oba & M. S. Allen, “Effects of Brown Midrib 3 Mutations in Corn Silage on Productivity of Dairy Cows Fed Two Concentrations of Dietary Neutral Detergent Fiber: #3. Digestibility and Microbial Efficiency,” J. Dairy Sci. 83:1350-58 (2000).

Use of alfalfa as the primary source of effective fiber has been compared with corn silage in a dairy cow feed ration. See D. R. Mertens, “Creating a System for Meeting the Fiber Requirements of Dairy Cows,” J. Dairy Sci. 80:1463-81 (1997). Comparing the effectiveness of various NDF sources at stimulating chewing activity by cows and maintaining a functional ruminal digesta mat, Mertens discovered that alfalfa is generally more effective at stimulating chewing than corn silage, thereby exhibiting a higher effective NDF content. For example, alfalfa hay stimulated 109-134 minutes of chewing per kilogram of NDF, compared with only 66-96 minutes of chewing produced by corn silage. Two more recent papers have studied the effect of varying particle size of corn silage and alfalfa. Reducing particle size increased dry matter intake in a linear fashion, and total chewing activity exhibited a quadratic response with the highest chewing activities observed for diets with the shortest and longest particle sizes. While time spent by the cows on eating and ruminating remained unchanged, the NDF concentration of feed remaining in the feed bin decreased. See P. J. Kononoff, A. J. Heinrichs, H. A. Lehman, “The Effect of Corn Silage Particle Size on Eating Behavior, Chewing Activities, and Rumen Fermentation in Lactating Cows,” J. Dairy Sci. 86:3343-53 (2003). See also P. J. Kononoff & A. J. Heinricks, “The Effect of Reducing Alfalfa Haylage Particle Size on Cows in Early Lactation,” J. Dairy Sci. 86:1445-57 (2003).

Other research has been directed to the use of nonforage sources of digestible fiber (“NFFS”) in feed rations. It has been determined that use of NFFS's in conjunction with high-starch diets results in improved cow response. Such NFFS's included soybean hulls and cottonseed hulls. See R. Grant, Proc. Eastern Nutrition Conference, May 11-12, 2006, Guelph, Ontario, Canada; J. L. Beckman & W. P. Weiss, “Nutrient Digestibility of Diets with Different Fiber to Starch Ratios When Fed to Lactating Dairy Cows,” J. Dairy Sci. 88:1015-23 (2005).

Starch in grain is a common feed ingredient for lactating dairy cows because it can be readily converted to energy. One study concluded that in corn harvested for silage or grain, the protein matrix regulates the rate and extent of digestion of the exposed corn endosperm. Y. Wang, D. Sapienza, V. J. H. Sewalt, Z. Xu, and T. A. McAllister, “The Role of Protein Matrix in the Digestion of Corn Grain: Assessment By Scanning Electron Microscopy,” J. Dairy Sci. 88 (Suppl. 1): 315 (2005). The resulting vitreousness of the endosperm can accurately predict the starch degradation in the rumen. C. Philippeau, C. Martin, and B. Micholet-Doreau, “Influences of Grain Source on Ruminal Characteristics, and Rate, Site, and Extent of Digestion of Beef Steers,” J. Animal Sci. 77:1587-96 (1999); C. Philippeau, F. Le Deschault de Monredon, and B. Micholet-Doreau, “Relationship Between Ruminal Starch Degradation and the Physical Characteristics of Corn Grain,” J. Animal Sci. 77:238-43 (1999).

Some studies have determined that vitreousness has greater impact on ruminal and total tract dry matter and starch digestibility at black-layer versus early-dent stage of maturity. See, e.g., G. A. Celestine, M. N. Pereira, R. G. S. Bruno, R. G. VonPinho, and C. E. S. Correa, “Effect of Corn Grain Texture and Maturity on Ruminal In Situ Starch Degradation,” J. Dairy Sci. 84 (Suppl. 1): 419 (2001); D. Ngonyamo-Majee, R. D. Shaver, J. G. Coors, D. Sapienza, J. G. Lauer, and C. Venhaus, “Effect of Kernal Vitreousness on Ruminal and Total Tract Dry Matter Digestibility of Diverse Corn Germplasm Sources,” J. Dairy Sci. 871 (Suppl. 1): 216 (2004). However, a French group of researchers found that at silage stage of maturity (ca. 30% DM), the difference in starch degradation between dent and flint genotypes was high and similar to that measured at maturity of the grain. C. Phillipeau and B. Micholet-Doreau, “Influence of Genotype and Stage of Maturity of Maize on Rate of Ruminal Starch Degradation,” Animal Feed Sci. Technol. 68:25-35 (1997); Philippeau et al. (1999); C. Philippeau & B. Micholet-Doreau, “Influence of Genotype and Ensiling of Corn Grain on In-Situ Degradation of Starch in the Rumen,” J. Dairy Sci. 81:2178-84 (1998). Although ensiling increases rumen starch degradation, the differences in ruminal starch degradation between dent and flint corn remains constant whether or not the corn is ensiled. Philippeau, et al. (1997).

Endosperm type and starch degradability of corn was evaluated in a comprehensive study conducted by Allen, et al. In a multi-state study (Michigan, Nebraska, Pennsylvania) directed to floury, opaque-2, waxy, dent, and flint endosperm types, the corn was harvested at 40, 30 and 20% moisture, and ensiled in mini silos. In this study, starch degradation of the hybrids was found to be highly related to vitreousness (R²=0.96). Increased starch degradation with increased time of ensiling and moisture content was associated with increased kernel fragility. Texture (vitreousness) was determined to have the greatest impact on starch digestion (in-situ and total tract) when the corn was harvested at the black-layer stage. M. S. Allen, R. J. Grant, W. P. Weiss, G. W. Roth, and J. F. Beck, “Effect of Endosperm Type of Corn Grain on Starch Degradation By Ruminal Microbes In-Vitro,” J. Dairy Sci. 86 (Suppl. 1): 61 (2003). See also Celestine, et al. (2001); Nyonyamo-Majee, et al. (2004).

Only three studies have reported the effect of endosperm type (vitreousness) on dairy cow performance. I. Andrighetto, P. Berzaghi, G. Cozzi, G. Magni, and D. Sapienza, “Effect of Grain Hardness on In-Situ Degradation of Corn and on Milk Production,” J. Dairy Sci. 81 (Suppl. 1): 319 (1998); K. C. Fanning, R. A. Longuski, R. J. Grant, M. S. Allen, and J. F. Beck, “Endosperm Type and Kernal Processing of Corn Stage: Effect on Starch and Fiber Digestion and Ruminal Turnover in Lactating Dairy Cows,” J. Dairy Sci. 85 (Suppl. 1): 204 (2002); R. A. Longuski, K. C. Fanning, M. S. Allen, R. J. Grant, and J. F. Beck, “Endosperm Type and Kernal Processing of Corn Silage: Effects on Short-Term Lactational Performances in Dairy Cows,” J. Dairy Sci. 85 (Suppl. 1): 204 (2002). None of these studies found any effect of corn vitreousness on DMI or milk yield; however, Longuski, et al. did find a significant increase in FCM/DMI with floury versus vitreous corn silage. None of these studies, however, attempted to combine the characteristics of the starch from both the corn silage and supplemental corn grain. To date, there is no strong evidence demonstrating the effect of altering endosperm texture on cow performance.

One published research study has directly evaluated the concept of optimizing NDF and starch digestibility. C. C. Taylor & M. S. Allen, “Corn Grain Endosperm Type and Brown Midrib 3 Corn Silage: Site of Digestion and Ruminal Digestion Kinetics in Lactating Cows,” J. Dairy Sci. 88:1413-24 (2005); C. C. Taylor & M. S. Allen, “Corn Grain Endosperm Type and Brown Midrib 3 Corn Silage: Feeding Behavior and Milk Yield of Lactating Cows,” J. Dairy Sci. 88:1425-33 (2005); C. C. Taylor & M. S. Allen, “Corn Grain Endosperm Type and Brown Midrib 3 Corn Silage: Ruminal Fermentation and N. Partitioning in Lactating Cows,” J. Dairy Sci. 88:1434-42 (2005). The study found that starch and fiber digestibility interact to affect feeding behavior and milk production. A cow's response to high-NDF digestibility forage (e.g., BMR corn silage) depends upon the grain source fed (i.e., vitreous vs. floury). This study indicated that a combination of floury endosperm grain and high-NDF digestibility corn silage resulted in the greatest feed intake, milk yield, larger meals, and more meals consumed per day. See also PCT Application WO/096191 published on Dec. 2, 2002 (Beck, et al.).

In addition to corn genotype (floury, flirty), varying corn grain particle size has been found to be an efficient tool for manipulating rumen degradability of corn starch. D. Remond, J. F. Cabrera-Estrada, M. Champion, B. Chauveau, R. Coudure, and C. Poncet, “Effect of Corn Particle size on Site and Extent of Starch Digestion in Lactating Dairy Cows,” J. Dairy Sci. 87:1389-99 (2004). In this study, the decrease in the amount of starch fermented in the rumen with coarse rolling was partially compensated for by an increase in the amount of starch digested in the small intestine with dent genotype, but with semi-flint genotype corn, post-ruminal digestion was not increased, and rumen escape starch was not utilized by the animal.

However, most of this dairy cow nutritional research has focused upon the influence of single variables in a feed ration upon the cow's performance. No real effort has been made to combine multiple feed variables in order to obtain greater increases in rumen productivity. Moreover, the published dairy cow nutrition research has focused upon the quantity of milk produced by a cow, as opposed to other important characteristics of dairy cow productivity like maximizing milk peak and maintaining milk production stability and persistency across each stage of the lactation cycle, while maintaining the protein and fat components inside the milk and limiting health issues for the cow herd. It would therefore be advantageous to pursue an integrated approach to dairy cow nutrition by creating synergies between multiple forage components supplemented by a strategically blended grain component having a complementary starch digestion profile for maximizing the profitability of a dairy farm. It would also be beneficial to analyze the nutritional content of feed components in real time to ensure more accurately balanced feed rations, and reassess the feed components fed to the cows during the lactation cycle to enable the ration to be reformulated as needed for the nutritional needs of the individual cow, as opposed to the larger group of cows. Finally, it would be useful to provide a system to dairy farms that wish to use such enhanced feeding method that supplies them with genetics needed to grow feed ingredients for such feed rations, informational inputs required to practice the unique feeding method, and a source of feed ingredients that they may not wish to produce themselves, or may run short of. Such a system could also provide the dairy farm with the nutritional and feeding templates for the feed method, and rebalance them as needed for their cows.

### SUMMARY OF THE INVENTION

A method for feeding a ruminant animal a feed ration for enhancing its milk production stability across a multiple-stage lactation cycle is provided according to the invention. The feed ration should contain: at least one primary forage source selected from the group consisting of brown midrib corn silage, leafy corn silage, dual purpose corn silage, and grass silage for creating a ration forage composition with specific NDF and NDFd levels; a secondary forage source selected from the group consisting of dual purpose corn silage, alfalfa, alfalfa dry hay, grass silage, and alfalfa/grass mix for contributing to a specific level of NDF, forage particle size and crude protein to the feed ration; a blended corn grain containing a base dent corn germplasm or “mutt” corn into which is blended separate sources of floury and/or vitreous endosperm starch grain in order to achieve a predetermined level of in vitro starch digestibility to create optimum propionic acid within the cow upon digestion of the grain; such blended grain component being further processed to produce a specific particle size of the blended starch to further refine the level and site of propionic acid production within the cow. The corn grain may alternatively contain a floury or vitreous endosperm starch grain into which the opposite endosperm type is blended in order to achieve the desired starch digestibility level without any need for a base normal dent or mutt corn grain. A feed ration prepared in accordance with this method optimizes the ruminal environment inside the cow that consumes the feed ration for producing optimum feed intake level and site of starch degradation, and energy intake necessary for producing the enhanced milk production stability.

In order to deliver feed value to the pinpointed needs of the individual cow level, as opposed to herd level, the feed ration should be formulated in accordance to a particular cow stage of production (e.g., transition fresh, early/mid lactation, late lactation). The nutritionist should also check the aggregate fiber and starch digestible matter contributed by all of the feed ingredients in accordance with a “ration fermentability index” range for that particular stage of production to ensure that the ration will not contribute too much or too little digestibility to the cow at that moment in time. The feed ration may then be rebalanced as needed. Finally, the change in milk production in response to the feed diet should be monitored for each cow within the production stage group and compared with that cow's prior baseline production level to determine whether the cows should be regrouped within the production stage to enable separately reformulated rations to further enhance the performance of high-producer cows, while ameliorating the performance of low-producer cows.

This invention also provides a feed delivery system for a dairy farm wherein a third-party supplier of the system can provide the dairy farm with lists of approved hybrids or varieties for the primary forage, secondary forage, floury endosperm, and vitreous endosperm starch components of the feed ration, a nutritional template for the ingredients necessary to produce a the feed ration, a software interface for incorporating the nutritional template data into a feed formulation software for preparing a feed template for the feed ration, and a software interface for calculating the total volume of forage and starch ingredients that need to be produced or sourced for the feed ration. The third-party supplier can also supply the dairy farm with all or a portion of its component needs for the feed ration, in particular the specialty starch endosperm components that need to be segregated after production.

Moreover, the third-party supplier can provide the dairy farm, pursuant to the feed delivery system, with real-time characterizations of the fiber digestibility or starch digestibility of at least one forage or starch component, respectively, to enable more accurate formulation of the feed ration for a cow production stage, or reformulation of the nutritional template during the production stage for a cow to address the changed fiber or starch digestibility content of the forage or starch ingredients. Finally, the third-party supplier can supply the dairy farm with a revised cow penning strategy and reformulated nutritional templates to address the variable milk production levels of cows within a production group during a production stage.

### BRIEF DESCRIPTION OF THE DRAWINGS

In the accompanying drawings:

FIG. 1 is a graph illustrating the lactation cycle for a dairy cow.

FIG. 2 is a graph showing unstable versus stable milk production during a lactation cycle.

FIG. 3 is a schematic diagram of the feeding method and associated tools and business method of the present invention.

FIG. 4 is a schematic diagram of the method for preparing a Nutrition Template, Forage Template, Starch Template, and Feeding Template under this invention.

FIG. 5 is a schematic diagram of the method for preparing the Nutritional Template.

FIG. 6 is a schematic diagram of the method for preparing the Forage Template and delivering forage ingredients to the dairy farm.

FIG. 7 is a schematic diagram of the method for preparing the Starch Template and delivering grain ingredients to the dairy farm.

FIG. 8 is a schematic diagram of the identity preserve system for delivering forage and grain ingredients to the dairy farm for addressing seasonal variability factors.

FIG. 9 is a schematic diagram of an on-farm storage system for a dairy farm utilizing the feeding method and delivery system of the present invention.

FIG. 10 is a schematic diagram of a system for re-penning dairy cows and reformulating their feed rations based upon a comparative analysis of their milk production.

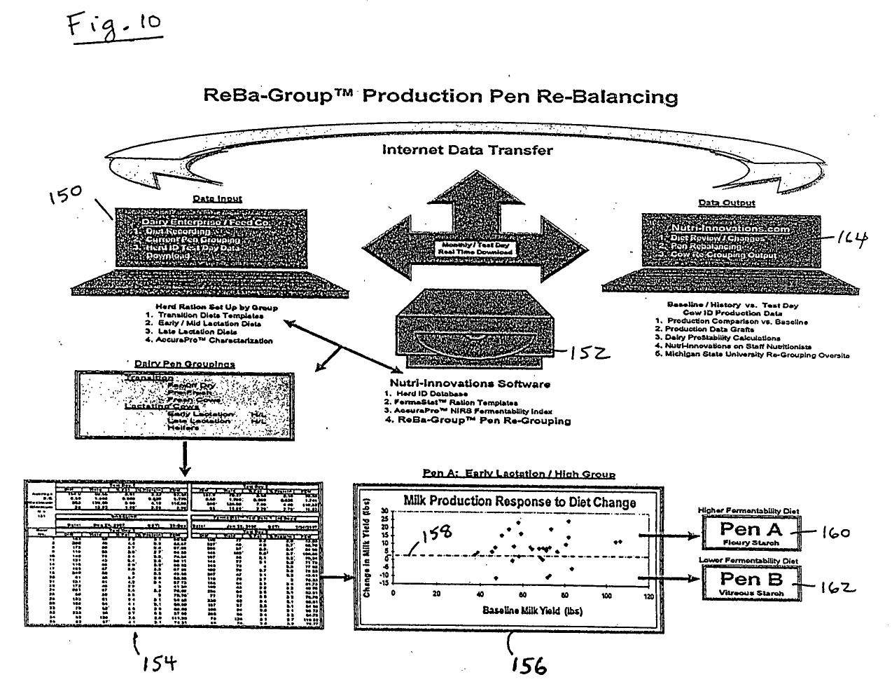

### DETAILED DESCRIPTION OF THE PREFERRED EMBODIMENT

An integrated feed delivery system for providing optimized nutrition to ruminant animals is provided by the invention. Such system combines the knowledge of feed programming and dairy cow rumen function with the digestibility characteristics of forage and grains to build ration templates for specific stages of production of dairy cows. This invention provides a system that incorporates at least two specific forage sources and ration forage specifications to build the synergistic base forage diet to which a blended starch grain is then added to influence the quantity of the production of propionate VFA and the site of its absorption within the cow's gastrointestinal tract. This targeted digestibility of starch is controlled and regulated by characterizing the rate and extent of digestibility of the corn genetic source (grain) and the conservation of this starch by specific particle size by processing. A blend of these sources of grain starch and specific particle size is created to achieve the desired starch digestibility profile. This whole program is packaged in a delivery system to the dairy to synergistically increase efficiencies with the existing farm model to maximize net milk production and milk peak, and maintain production stability within each stage of the lactation production cycle, while maintaining desirable milk components (e.g., protein and fat), and limiting herd health issues. The multiple ingredient variables incorporated into this approach to construct a feed ration enable the ration to be adjusted for environmental variability and the specific energy needs of the ruminant herd production group for the given phase of the lactation cycle.

In order to deliver feed value to the pinpointed needs of the individual cow level, as opposed to herd level/group pen level, the feed ration should be formulated in accordance to a particular cow stage of production (e.g., transition fresh, early/mid lactation, late lactation). The nutritionist should also check the aggregate fiber and starch digestible matter contributed by all of the feed ingredients in accordance with a “ration fermentability index” range for that particular stage of production to ensure that the ration will not contribute too much or too little digestibility to the cow at that moment in time. The feed ration may then be rebalanced as needed. Finally, the change in milk production in response to the feed diet should be monitored for each cow within the production stage group and compared with that cow's prior baseline production level to determine whether the cows should be regrouped within the production stage to enable separately reformulated rations to further enhance the performance of high-producer cows, while ameliorating the performance of low-producer cows.

This invention also provides a feed delivery system for a dairy farm wherein a third-party supplier of the system can provide the dairy farm with lists of approved hybrids or varieties for the primary forage, secondary forage, floury endosperm, and vitreous endosperm starch components of the feed ration, a nutritional template for the ingredients necessary to produce a the feed ration, a software interface for incorporating the nutritional template data into a feed formulation software for preparing a feed template for the feed ration, and a software interface for calculating the total volume of forage and starch ingredients that need to be produced or sourced for the feed ration. The third-party supplier can also supply the dairy farm with all or a portion of its component needs for the feed ration, in particular the specialty starch endosperm components that need to be segregated after production.

Moreover, the third-party supplier can provide the dairy farm, pursuant to the feed delivery system, with real-time characterizations of the fiber digestibility or starch digestibility of at least one forage or starch component, respectively, to enable more accurate formulation of the feed ration for a cow production stage, or reformulation of the nutritional template during the production stage for a cow to address the changed fiber or starch digestibility content of the forage or starch ingredients. Finally, the third-party supplier can supply the dairy farm with a revised cow penning strategy and reformulated nutritional templates to address the variable milk production levels of cows within a production group during a production stage.

For purposes of the present invention, “ruminant animal” means any animal having a multiple-compartment stomach for digesting feed ingredients ruminated by the animal, including but not limited to dairy cows, beef cows, sheep, goats, yaks, water buffalo, and camels. Examples of dairy cows particularly include Holstein, Guernsey, Ayshire, Brown Swiss, Jersey, and Milking Shorthorn cows.

In the context of the present invention, “lactation cycle” means the period of time during which a ruminant animal produces milk following the delivery of a new-born animal.

For purposes of the present invention, “fresh-lactation stage” means the time period immediately after delivery by the ruminant animal of the new-born animal during which the milk produced by the ruminant animal could be used for nursing the newborn. For a cow, this fresh-lactation phase lasts approximately 21 days. Note that for most dairy farms, dairy cows produce milk for commercial purposes during this fresh-lactation stage.

As used within this application, “early lactation stage” means the time period immediately following the fresh-lactation stage during which the daily volume of milk produced by the ruminant animal increases until peak production of milk is approached. For a dairy cow, this early-lactation stage approximates 100 days in duration.

For purposes of the present invention, “mid-lactation stage” means the time period immediately following the early lactation stage during which the ruminant animal is producing milk at close to the peak volume. For a dairy cow, this mid-lactation stage approximates 130 days in duration.

For purposes of this application, “late-lactation stage” means the time period immediately following the mid-lactation stage during which the ruminant animal continues to produce milk at a decreasing volume level until milk production ceases. For a dairy cow, this late-lactation stage approximates 75 days in duration.

As used within this application, the “far-off dry phase” means the time period immediately following the late-lactation stage until approximately 20 days before the next calving for a pregnant dairy cow during which the ruminant animal produces no milk.

For purposes of the present invention, “close-up dry phase” means the approximately 20-day period for a dairy cow following the far-off dry phase immediately prior to the next calving of a newborn calf.

As used within this application, “milk production” means the volume of milk produced by a lactating ruminant animal during a day, week, or other relevant time period.

For purposes of the present invention, “milk peak” means the highest level of milk production achieved by a ruminant animal during the lactation cycle.

For purposes of this invention, “milk stability” means production by the ruminant animal of milk across the lactation cycle in a manner that approaches the ideal lactation volume each day by achieving optimum milk peak and consistent milk persistence curves for the ruminant animal.

As used within this application, “nutritionist” means an individual responsible for specifying the composition of a feeding ration for a ruminant animal. Such nutritionist can be a dairy farmer, employee of a dairy farm company, or consultant hired by such a farmer or company.

As used within this application, “non-fiber carbohydrate” (“NFC”) is calculated as 100% crude protein+NDF+Fat+Ash. It contains primarily starch, sugars, and soluble fiber such as pectin. For common grains like corn and barley, the NFC is 80-90% starch and 10-20% sugars and/or pectin. Corn grain contains 80% starch and 20% sugar.

For purposes of this invention, “neutral detergent fiber” (“NDF”) means the insoluble residue remaining after boiling a feed sample in neutral detergent. The major components are lignin, cellulose and hemicellulose, but NDF also contains protein, bound nitrogen, minerals, and cuticle. It is negatively related to feed intake and digestibility by ruminants.

As used within this application “NDF digestibility” (“NDFd”) means the amount of NDF that is fermented by rumen microbes at a fixed time point and is used as an indicator of forage quality. Common endpoints for fermentation are: 24, 30, or 48 hours. NDFd is positively associated with feed intake, milk production, and body weight gain in dairy cattle.

For purposes of this invention, “lignified NDF” means the fraction of NDF that is protected from fermentation by its chemical and physical relationship with lignin. It is commonly referred to as indigestible NDF and is often estimated as (lignin×2.4).

As used within this application, “effective fiber,” more commonly referred to as “physically effective fiber” (“peNDF”), means the fraction of NDF that stimulates rumination and forms the digesta mat in the rumen. It is measured as the fraction of particles retained on the 1.18-mm screen when a sample is dry sieved.

For the present invention, “dry matter intake” means the amount of feed (on a moisture-free basis) that an animal consumes in a given period of time, typically 24 hours. Calculated as feed offered-feed refused (all on a moisture-free basis).

For purposes of the present invention, “volatile fatty acids” (“VFA”) are the end product of anaerobic microbial fermentation of feed ingredients in the rumen. The common VFA's are acetate, propionate, butyrate, isobutyrate, valerate, and isovalerate. The VFA's are absorbed by the rumen and used by the animal for energy and lipid synthesis.

The feeding method, feed composition, and on-farm feed delivery system of the present invention is discussed within this application for a dairy cow. However, it should be understood that this invention can be applied to any other ruminant animal including ruminants that are not used to produce milk like beef steers used for meat production.

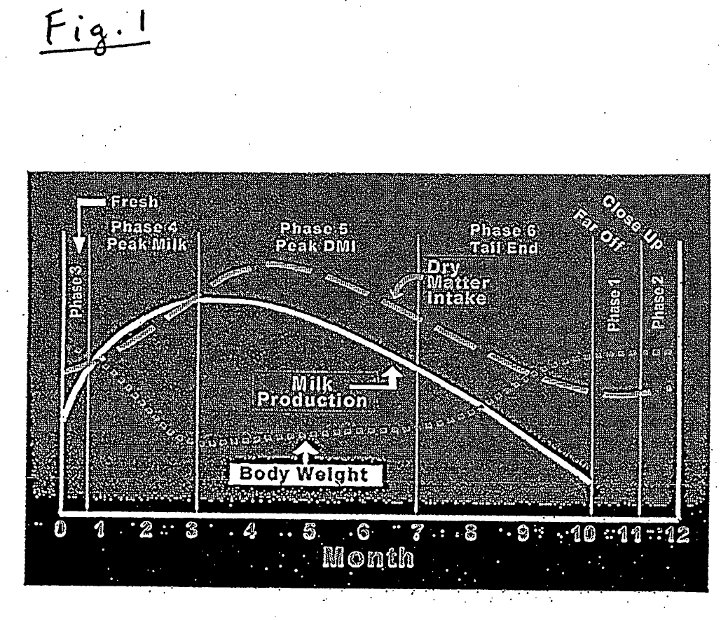

As shown more clearly in FIG. 1, a dairy cow produces its milk in accordance with the natural dictates of a lactation cycle. The pregnant cow will deliver its calf at time point zero to commence a “fresh phase” lasting approximately 21 days. The cow typically will then be moved by the dairy farmer into another group for the next approximately 305 days comprising the “early-lactation stage,” “mid-lactation stage,” and “late-lactation stage” during which milk is produced for commercial consumption.

Early-lactation usually refers to the first approximately 100 days of lactation (Day 22-Day 121). During this phase, the cow's milk production will increase to a peak point. Because of the increased energy requirements for the cow to produce this milk, the cow should be encouraged to maximize its dry matter intake of feed during this early-lactation stage. Each additional kilogram of dry matter feed consumed can support the production of approximately 2-2.4 kg more milk. This feed intake will be influenced by a variety of factors including level of production, forage quantity, forage quality, feed digestibility, feed processing, feeding frequency, and consistency of the feed ration ingredients. Because the milk yield will usually increase more rapidly than dry matter intake during this early-lactation stage, the net energy demand will cause the cow to mobilize its body fat to make up for this deficit, thereby resulting in a weight loss. The dairy industry has spent a great deal of time and money on trying to identify cows with a higher genetic potential for safely mobilizing this body fat for longer periods of time. Thus, not all dairy cows are equal in terms of producing milk. Good sources of dietary energy and protein are critical during this early-lactation stage.

The mid-lactation stage represents the time period from approximately Day 121 to approximately Day 251 after calving. By the beginning of this phase, the cow will have achieved peak milk production (8-10 weeks after calving). Peak dry matter intake has also been achieved with no additional weight loss. The dairy farmer will seek during this mid-lactation stage to feed the cow a ration that will maintain a high level of persistency in milk production. During this mid-lactation stage approximately 60-70 days after calving, the cow should also be bred or artificially inseminated to initiate a new pregnancy for the next lactation cycle. Satisfying high energy requirements is still important during this mid-lactation stage. Protein requirements are less critical than they were during the early lactation stage. Effective fiber levels are similar.

The late-lactation stage will begin approximately 251 days after calving and end when the cow's milk production dries off (at about Day 305 of lactation). During this period, milk yield and feed intake will both decline. The cow will also gain weight in order to replenish the adipose tissue lost during the early-lactation phase. As the end of the lactation period approaches, more of the increased body weight will be due to the growing fetus. Sources of protein and energy are less important during this late-lactation stage, because the requirements are much less than during early and mid-lactation. See M. Hutjens, Feeding Guide (W. D. Hoards and Sons Co., Fort Atkinson, Wisconsin 1998).

The “far off dry phase” of the lactation cycle commences for the cow after milk production ceases, and runs until approximately 20 days before calving. The “close-up phase” comprises this final 20 days before the next calves are born. The transition during these two phases from dry to lactation is stressful for the cow, and proper nutrition is critical to get the cow through the delivery of the new calf as uneventfully as possible.

Energy is the fuel required for supporting lactation by the cow, as well as the health and growth. Net energy for lactation (NE1; Mcal/lb) within the cow's feed ration should amount to approximately 0.76-0.80 during early-lactation, approximately 0.72-0.76 during mid-lactation, and approximately 0.69-0.72 during late-lactation. “Energy intake” is calculated as the product of dry matter intake (DMI)×the energy content of the feed. Low energy intake is problematic for young cows and high-producing cows. Inadequate and variable caloric intake can result in reduced growth, decreased milk production, depressed milk protein milk fat test, and impaired reproduction and health. At the same time, excessive energy intake by the cow, especially from rapidly fermented carbohydrates, can lead to over-conditioning, depressed milk fat production, and herd health issues. Such over-feeding can pose a problem for cows in mid and late-lactation stages, and for dry cows.

Feed ingredients should supply sources of nutrients, fiber, and particle size to the cow that are necessary for normal digestion, metabolism, and performance. “Forages” are perennial and annual crops grown at pasture, green chop, haylage, silage, or hay that have been harvested at the optimum maturity, moisture content and proper length. They contain significant levels of protein, fiber, energy, Vitamin E and Vitamin D if they have been sun-cured. For purposes of this invention, the forages are prepared as dry-cured and aerobically-stable fermented silages. “Roughages” are crops or processing wastes of adequate particle size that are high in fiber, and relatively low in energy content. Common roughages include cereal, straw, cornstalks, cottonseed hulls, corn cobs, and apple pomace with hulls. “Concentrates” are cereal grains and by-products feedstuffs containing relatively high energy levels. Concentrates will usually have finer particle sizes than harvested forages.

A number of different variables impact the effective delivery to and utilization by the dairy cow of nutritional ingredients contained in a feed ration. Called the “GELT Effect” by Applicant, the variables include genetics, environment, location, and traits. The specific genetics of the cow will directly influence its ability to digest and absorb the nutritional ingredients. Likewise, the specific genetics of the forage and grain components of the feed components can directly influence their nutritional content of carbohydrates, protein, and fiber. Therefore, corn genetics used for corn silage production have a significant range of NDF content, NDFd, and percent starch content. Likewise, grain genetics have a wide range of oil, protein, starch composition, and rate and extent of starch digestibility. Thus, the seed genetics determines the potential of each forage and grain quality trait to deliver nutrition to the cow. Failure to use appropriate agronomic inputs (e.g., fertilizers, herbicides, fungicides, pesticides) and levels thereof can also have a deleterious effect upon the quality trail characteristics of the resulting crop grown from the seed.

The environment and weather conditions under which a crop is grown is another key source of variability. The weather is considered an uncontrollable event. No one growing season is the same from one year to the next in terms of temperature and moisture. This directly affects and adds a high degree of variation to forage production, forage quality, and starch digestibility that can create subsequent inconsistencies in a dairy cow's performance. For example temperature and rainfall patterns during a growing season can affect the level of fiber (NDF), the amount, and the effect of lignin on fiber digestibility (NDFd). This subsequently can affect how a forage “feeds,” and can have an increase or decrease effect on dry matter intake (DMI) and energy intake with dairy cows, especially cows that are limited by fill and in early lactation.

Starch digestibility within the kernels of a corn hybrid chopped for silage and corn grain used for energy supplementation can also be variable by a growing season environment. Both the content of starch and the rate and extent of digestion can be altered. Thus, supplement grain added to a diet and the corn grain within corn silage can positively and negatively affect dairy cow productivity. Hence the environment determines the level and range of each forage and grain quality trait.

The temperature and other feeding conditions can also directly influence the cow's willingness or ability to intake dry matter contained in feed rations. Thus, this environmental variation makes it almost impossible to predict and implement a feed programming strategy for a dairy cow in a given production year, or design a cropping or ingredient purchasing program for growing or procuring forage and grain feed ingredients without utilization of some type of real-time adjustment mechanism to account for this uncontrolled variation factor.

Specific harvesting techniques can also have a deleterious influence upon the nutritional content of the feed ingredient. Poor storage techniques (e.g., packing and storage) can also adversely impact the nutritional value of grain, forage or silage. Sampling protocols and laboratory testing errors arising during the analysis of the nutritional profile of a feed ingredient can interfere with construction of an appropriate feed ration. Moreover, the inoculants used to facilitate forage fermentation to produce silage, and preservatives for silage and grain storage can adversely impact the nutritional trails of the silage or grain product. Harvest management techniques therefore determine the net of each forage and grain quality trait. Of course, poor formulation of the feed ration can also affect the proper delivery of nutritional values to the dairy cow.

Therefore, it is important to appreciate that no two forage or grain samples are exactly the same in nutritional content, even if grown from the same seed variety or hybrid, and the nutritional content of different varieties and hybrids will probably vary significantly—all because of this GELT Effect.

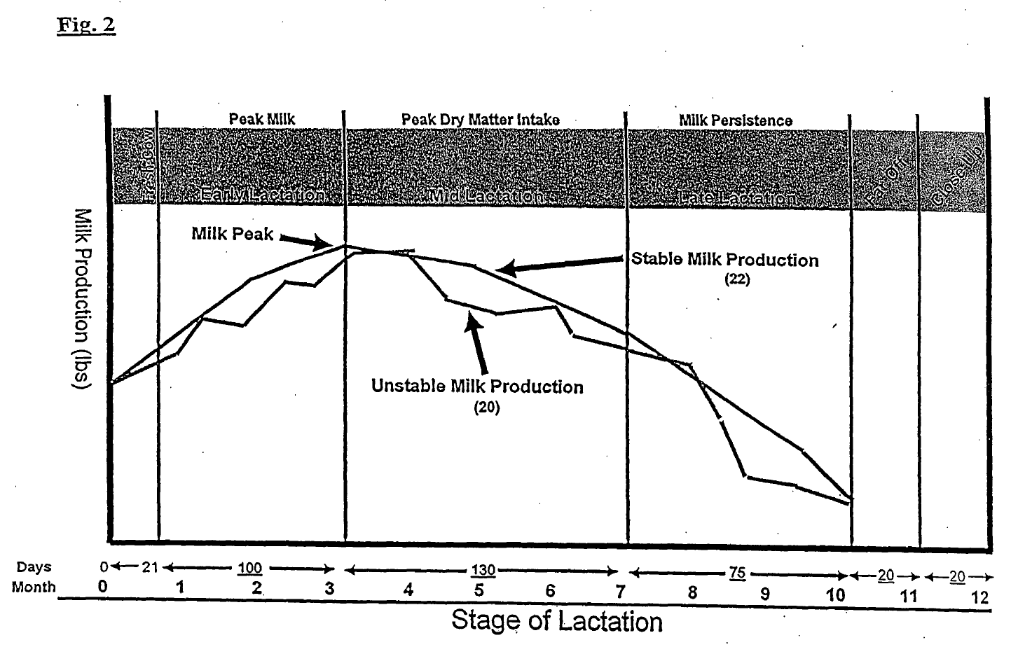

As shown more clearly in FIG. 2, the actual production of milk by the dairy cow throughout the fresh cow, early-lactation, mid-lactation, and late-lactation stages can exhibit many intermittent dips and peaks, thereby leading to unstable milk production, as depicted by line 20. Such peaks and dips may be caused by this GELT Effect variability of the nutritional content of the feed ration ingredients, animal feeding environment, inaccurate feed programming, and failure to adjust the feed ration composition for the dairy cow in response thereto. Line 22 represents stable milk production that can be achieved by use of the feeding method of this invention to prepare a feed composition that takes these variable factors into account and satisfies the energy and nutritional needs of the dairy cow during that particular point of the lactation production stage. Not only will the stability of milk production line 22 produce a higher and consistent milk peak for the dairy cow, but also the area between milk production lines 20 and 22 represents the loss in net milk produced by the failure to feed the dairy cow the feed composition of the present invention. Therefore, the feeding method of this invention stabilizes the natural environmental and man-made inconsistencies influencing milk production.

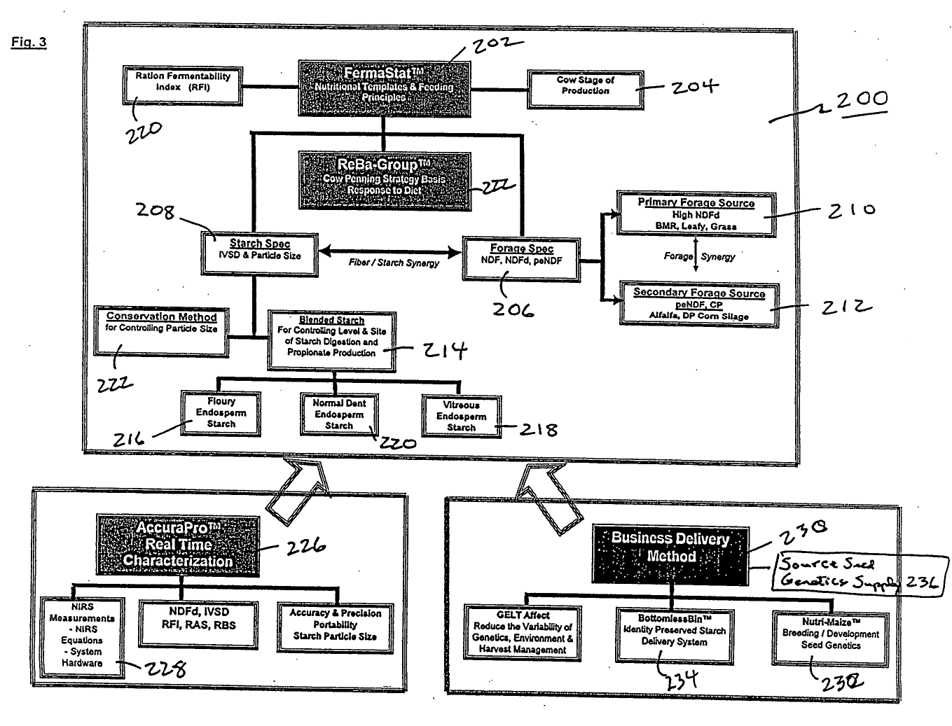

An overall feeding method 200 of the present invention is shown in FIG. 3, but is disclosed more fully in Applicant's U.S. Ser. No. 11/494,312 filed on Jul. 27, 2006, and a co-pending patent application entitled “Method and Feed For Enhancing Ruminant Animal Nutrition” filed on even date herewith, both of which are hereby incorporated in their entirety. The feeding method comprises a series of tools that may be used: individually to maintain milk production stability, maintain or enhance the milk components protein and fat, and result in more net milk and component price premiums for this milk; or in combination to further enhance these positive effects. Thus, a nutritional template 202 that is appropriate for a particular cow stage of production 204 is created. This nutritional template 202 is characterized by a forage specification 206 defining the NDF, NDFd, and peNDF values for the resulting ration, as well as a starch specification 208 that defines the in vitro starch digestibility (“IVSD”) for the ration. Two different forage sources are used within the ration: (1) a primary forage 210 that is characterized by high NDFd (along with some digestible starch) like BMR corn, leafy corn, grass, or dual purpose corn silage; and (2) a secondary forage 212 that contributes peNDF and crude protein like alfalfa or dual purpose corn silage. These two forage sources complement each other to create a forage synergy within the rumen of the cow to deliver the desired NDF, NDFd, and peNDF specifications.

A blended starch source 214 derived from corn grain is employed within the feed ration to control the level of starch digestibility (IVSD). Because of the GELT Effect on corn grain, a blend of floury endosperm starch 216 and/or vitreous endosperm starch 218 with a base starch like normal dent endosperm starch 220 may be used to manipulate the IVSD to the level set forth within the starch specification 208. In some cases, it may be possible to dispense with the normal dent endosperm base, and simply blend floury endosperm starch 216 and vitreous endosperm starch 218 to achieve the desired IVSD target. Moreover, conservation methods 222 known within the industry should be used to regulate the particle size of the resulting blended starch ingredient 214 to control the site of digestion of the starch within the cow's gastrointestinal tract. The starch and forage ingredients combined within the feed ration will create a further synergistic effect within the cow's rumen when consumed.

The feed ration produced from this nutritional template may be fed to the cows within the production stage to enhance their milk production and milk stability. Because of the variability of the forage and starch components due to the GELT Effect, it is beneficial to subject these ingredients to real-time characterization for NDFd, IVSD, RAS, and RBS via real-time characterization tool 226. A portable tool based upon NIRS equations and system hardware 228 that will be described more fully herein, this real-time characterization tool 226 enables accurate and precise measurement of the forage and starch ingredients in the field, so that nutritional templates 202 that more accurately comply with the forage specifications 206 and starch specifications 208 may be created.

It is also important within the feeding method 200 of the present invention to accurately account for the entire NDFd and IVSD contributed by the forage and starch sources (including RAS and RBS), so that feed ration does not unwittingly over-deliver or under-deliver its nutritional profile. A ration fermentability index (“RFI”) 220 that will be more fully described herein characterizes this total NDFd and IVSD for the feed ration. Furthermore, this RFI should be measured several times during a production stage in order to enable the feed ration to be rebalanced if necessary.

While it is convenient to aggregate cows within a production group for feeding the same ration, in reality no two cows are the same in their response to a feed diet, whether due to their physiology or health, or both. Therefore, another important tool under the feeding method 200 of the present invention is to regroup the cows 222 during the course of the production stage. As more fully described herein, the individual cows should be evaluated for their response to the feed diet against their baseline production with the high-producers put in one subgroup and the low-producers placed in another subgroup. This re-penning strategy 222 enables the feed ration to be reformulated for each subgroup of cows in order to liberate the high-producers to produce even more milk and milk stability, and the low-producers to recover their health and their baseline level of milk production and stability.

Finally, the dairy farmer or nutritionist utilizing such unique feeding method will require the nutritional templates 202, feeding templates, identification of appropriate seed genetics 232 for growing the necessary forage and starch source components, and delivery of feed components 234, in particular starch components, that cannot be produced on the farm. The business delivery system 230 can provide these critical inputs and associated proprietary data and information for the successful practice of the feeding method 200.

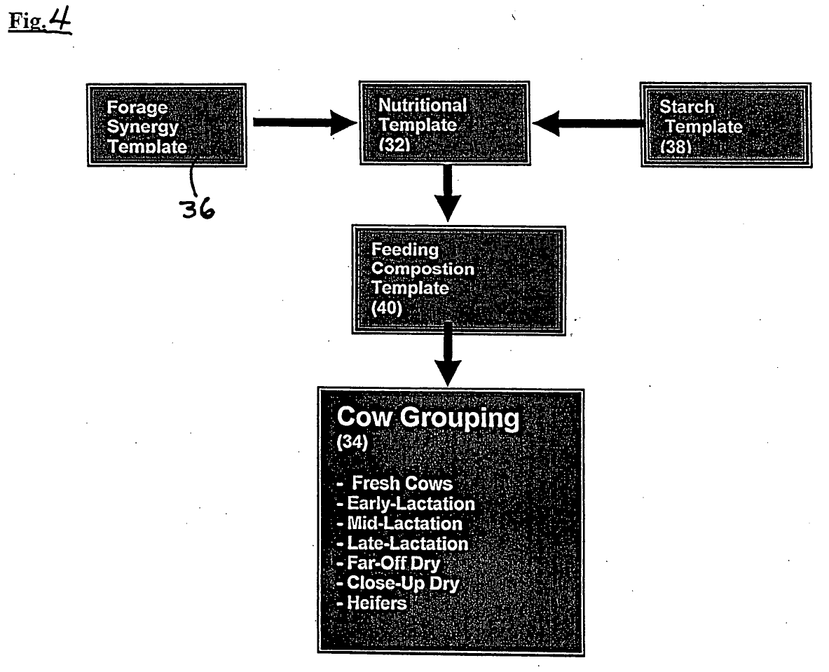

As shown more fully in FIG. 4, the feeding method 30 of the present invention comprises the development of a nutritional template 32 for the dairy cows. This Nutritional Template will set the base forage ration parameters, identify and incorporate the best forage options by source and composition ratio, and identify the optimum starch digestibility profile to create a fiber/starch rumen synergy. The specific targets of energy, protein, fiber, and other nutritional needs of the dairy cow are set forth for feeding all stages of production. Because of the varying nutritional requirements for the dairy cow throughout the lactation cycle, this Nutritional Template 32 takes into account the current lactation cycle stage of the cow group being fed. Because the dairy farm will typically feed more than one cow, the cows should preferably be divided into separate production groups for fresh cows, early-lactation cows, mid-lactation cows, late-lactation cows, far-off dry cows, close-up dry cows, and heifers, through grouping step 34. A forage template 36 should then be constructed for the forage components to be used for partially satisfying the requirements of the Nutritional Template 32. Meanwhile, a starch template 38 should be created for the grain components to be employed for providing other requirements of the Nutritional Template 32. Finally, a feed composition template 40 should be formed specifying the specific dietary dry matter pounds of forage, grain, and other feed ingredients to combine into a Total Mix Ration (TMR) needed to satisfy the nutritional needs of the dairy cow for its production stage 34, as embodied by the Nutritional Template 32, Forage Template 36, and Starch Template 38.

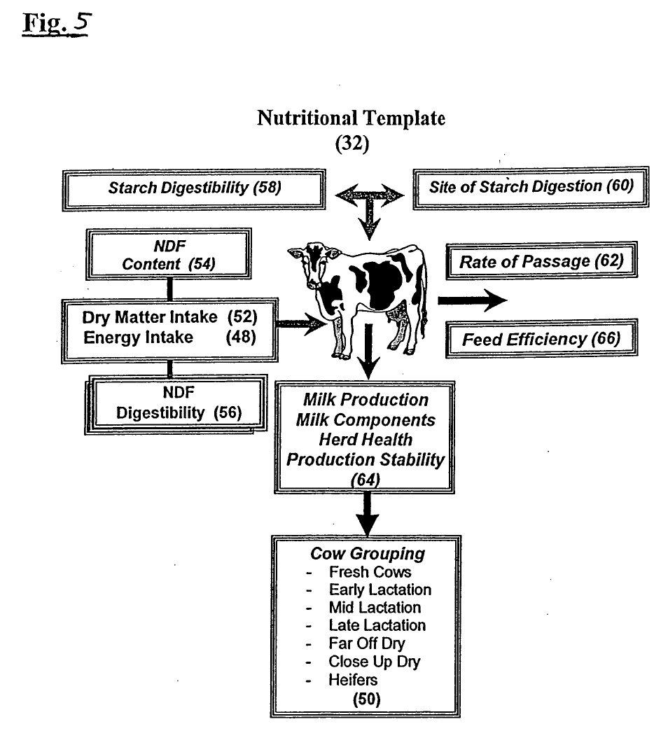

The method and nutritional inputs for constructing the Nutritional Template 32 are illustrated in FIG. 5. The cow 46 will require a particular amount of energy, protein and sufficient fiber (NDF) 48 depending upon its production stage grouping 50. This should translate into a volume of dry matter intake 52 that cow 46 should consume from the feeding ration within a day. The NDF content 54 of a forage component of the feed ration provides effective fiber for rumen mat creation for rumen motility, acetate VFA for milk fat production and, will promote salivation by the cow during its rumination of the ration to produce buffering agents necessary for maintaining proper pH of the cow's rumen. The forage components, in turn, should contain an appropriate level of NDF digestibility (“NDFd”) 56 to ensure that the cow 46 can adequately digest the forage and optimize dry matter intake within its rumen.

The majority of the cow's energy intake need will usually be provided by grain and concentrate components. Such grain ingredients must be characterized by a prescribed level of starch digestibility 58, so that the cow can adequately digest the starch contained within the grain to produce energy needed for lactation. At the same time, site of the starch digestion 60 within the gastrointestinal tract is important for producing optimum propionate levels and maintaining a rumen pH of 6.2-6.8 for optimum function. Propionate VFA is a 3-carbon fatty acid that serves as a primary gluconeogenic substrate used to synthesize glucose in ruminant animals.

Finally, a desirable rate of passage 62 of the feed ingredients through the cow's gastrointestinal tract is necessary for maximizing dry matter intake and ensuring that the feed ingredients can be adequately digested and the nutrients contained therein are absorbed across the rumen and small intestinal walls. In this manner, an enhanced level of milk production with a desirable level of fat, protein, and other milk components, and production stability 64 can be achieved. The health of the cow 46 free from unwanted metabolic illnesses and other deficiencies can also be obtained. The conversion of the feed ingredients to produce the enhanced milk production, milk components, milk production stability, feed efficiency and herd health 64 is defined as “cow profitability.” Further gains in cow profitability through feed efficiency can result from lower feed costs as reflected by less feed to produce a pound of milk 66. It is commonly known by skilled nutritionists within the dairy industry how to construct such a Nutritional Template 32 from the needs of the cow 46.

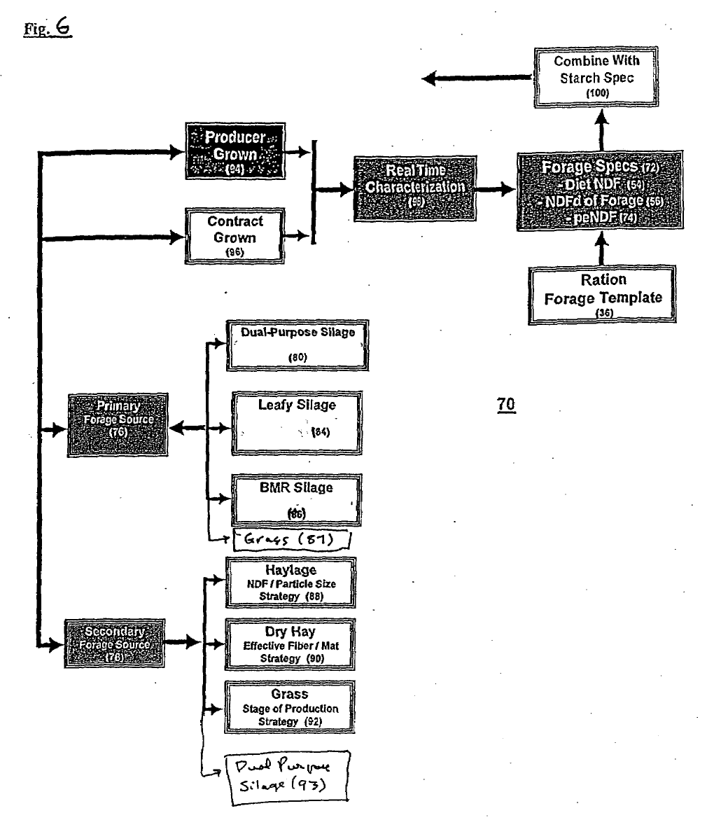

The process 70 of the present invention for constructing the Forage Template 36 for the dairy cow is shown in FIG. 6. The necessary specifications 72 for the forage ingredients, including NDF content 54, NDFd level 56, and physically effective fiber (peNDF) 74 are determined.

Next, the forage components for the feed ration may be drawn from a variety of different sources, and are divided into a primary forage source 76 and a secondary forage source 78. In one embodiment of the invention, the primary forage source 76, in turn, may be supplied by dual-purpose corn silage 80, leafy corn silage 84, BMR corn silage 86, grass 87, or a combination thereof. Silage constitutes a whole forage plant having a suitable whole plant moisture content, preferably between 65-70%. By use of mechanical harvesting equipment, the plant is chopped into pieces or a length of chop of between ¼-¾ inches long and packed into a storage structure for fermentation. The fermentation process consists of two phases. Aerobic (respiration of oxygen) and anaerobic (without oxygen, the actual fermentation). During this storage process, the chopped plant pieces will become compressed under the weight of the material, and through a respiration process, consume trapped oxygen within the cell walls of the forage and trapped within storage structure, thereby emitting CO₂ and water and heat. During the anaerobic phase of fermentation, lactic acid is the primary VFA produced to preserve and stabilize the forage indefinitely. The silage must be protected from exposure to oxygen in the air during this ensilage process and storage thereafter in order to avoid spoilage. The process of filling the storage structure and mechanical packing creates a barrier against oxygen penetrating the silage mass. The resulting ensiled silage product retains a large portion of the nutrients present in the plant and the fermentation VFA's—much more so than if the crop were simply dried and stored as hay or stover.

Dual-purpose corn is characterized by a low-NDF content of approximately 36-42%, a high-starch content of 30-36%, and a 30-hour in vitro NDFd level of approximately 43-48%. Leafy corn genetics are a special corn plant derived from mutagenesis and selective breeding characterized by a high-NDF content of approximately 46-55%, a low-starch content of approximately 22-26%, and a NDFd level of approximately 50-54%.

Brown midrib (“BMR”) corn is a special corn plant derived from mutagenesis and selective breeding that contains the bm3 gene. BMR corn is characterized by a low NDF content of approximately 32-36%, a high-starch level of approximately 32-38%, and a very high NDFd level of approximately 58-64%. Table 1 summarizes the NDF content, starch content 30-hour in vitro, NDFd, and lignified NDF trait ranges for each of these primary corn silage sources.

TABLE 1
Error!Forage Source
Forage Quality Profile

| | % NDF | % Starch | NDFd | Lignified |
|---|---|---|---|---|
| Forage Source | % DM | % DM | % of NDF | NDF |
| Dual-Purpose CS | 36-42% | 30-36% | 43-50% | <6.0 |
| Leafy CS | 46-55% | 22-26% | 50-54% | <5.5 |
| BMR CS | 32-38% | 30-38% | 58-64% | <4.5 |
| Grass | 50-55% | N/A | 48-52% | <8.0 |

Lignified NDF = % Lignin/% NDF × 100
NDFd = 30 hr. IVNDFD Digestibility Method

Forage particle size is the measurement of the length of forage particles, typically determined by sieving a sample. Ruminants require a minimum amount of coarser particles to stimulate rumination, contribute to the development of a rumen mat to regulate rate of passage of feed, and maintain rumen health. A common method of assessing particle size is dry sieving the sample followed by measuring the fraction of forage particles retained on the 1.18-mm screen (referred to as physically effective NDF (peNDF).

A necessary part of the feeding method and system of the present invention is the screening of commercially available hybrids each year to determine which ones satisfy the required parameters for the various corn silage components. These commercially available hybrids contain a wide variation in these characteristics, and thus must be screened and identified for use with the invention while new hybrids will be introduced to the market and old ones removed from the market. A supplier of the feed delivery system 200 of the present invention can provide a valuable service to its dairy farm customers by performing this important screening function and supplying a list of acceptable hybrids 232 that in accordance with FIG. 3 can be planted to produce the necessary corn silage components for the feed ration or the harvested silage purchase for use in such rations.

The secondary forage source 78 for the present invention may be supplied by alfalfa haylage 88, alfalfa hay, dry hay 90, grass silage 92, an alfalfa/grass mixture, dual purpose corn 93, or forage sorghum (e.g., brown midrib). Alfalfa is historically a difficult forage crop to maintain a consistent forage quality profile. This is because of the multiple harvests required (3-4) over a growing season and the timing of putting up the crop under ideal weather and drying conditions. The weather pattern for a growing season, especially temperature-induced lignification of the NDF and leaf loss from damaging rains can dramatically change the NDF level, crude protein content or digestibility of the forage (NDFd) even though the fiber content can remain relatively stable.

As shown in Table 2, for purposes of the feed method of the present invention, a desired alfalfa forage quality target for the crop managers to maintain will be higher in fiber (NDF) then traditionally managed alfalfa forage. A net NDF level of the alfalfa will be between 40%-42% rather then under 40% as typically practiced. This is because the alfalfa will be required to supply a large percentage of the effective fiber or peNDF of the diet coming from forage. This could also change harvest intervals of each of the cuttings to be longer in days and may require a shift of a 4 cut system to a 3 cut. This shift could positively increase the total dry matter yield recovered over a growing season with less exposure to poor hay harvesting conditions.

TABLE 2
Forage Source
Forage Quality Profile

| Forage | % NDF | % Starch | NDFd | Lignified |
|---|---|---|---|---|
| Source | % DM | % DM | % of NDF | NDF |
| Alfalfa Haylage | 40%-42% | N/A | 48%-52% | <15.0 |
| Alfalfa Dry Hay | 42%-44% | N/A | 48%-52% | <15.0 |
| Alfalfa/Grass Mix | 45%-50% | N/A | 44%-48% | <12.0 |

Lignified NDF = % Lignin/% NDF × 100
NDFd = 30 hr. IVNDFD Digestibility Method

Because alfalfa quality is so variable due to harvest management, inconsistent weather for optimum harvest, or lignification of the NDF from high temperatures, alfalfa is designated the secondary forage source as a percentage of the forage program, and should be programmed as an NDF and protein source, and effective fiber (peNDF) tool during ration formulation. BMR corn silage will be substituted when needed to add more NDFd to the diet when alfalfa quality becomes below specs to meet the feeding specifications of a particular ration and feeding strategy. When alfalfa NDF exceeds 44% and the NDFd drops below 40%, a DM substitution of BMR corn silage will be a useful remedy.

Dry bailed hay will be a secondary source of alfalfa forage to use as a source of effective fiber to the diet and neutralize the unstable effects of extremely high fiber digestibility from environmental affects of other forage sources. Its NDF content of approximately 42-44% will be slightly higher than the NDF content provided by the haylage. Fresh cows and early and mid-lactation cows may be fed haylage 88 or dry hay 90 as the secondary forage source 78.

An option for the Forage Template 36 is the inclusion of grass forage (i.e., orchard/brome) in the ration specs for late-lactation, far-off dry cows, close-up dry cows, and heifers. These cows could benefit by using grass as a ration addition by improving milk production, lowering feed costs and reduced herd health issues from over consumption of energy intake by cows in a positive energy balance.

Again, the feed delivery system 200 of the present invention can screen appropriate genetics for these secondary forage sources, and supply a list of acceptable hybrids or varieties 232 to the dairy farm, so that such feed can be planted to produce the necessary forage components. If the dairy farm does not wish to plant and harvest the primary and secondary forage ingredients, then it can purchase (236) these ingredients from the feed delivery system 200.

Thus, a critical step in diet formulation for the feeding method is determining the proper fit of the source of forages to be grown and in determining the forage platform for the dairy. Each feeding strategy by production group will be assigned a primary and secondary forage source structure to build the forage spec around. Deference can be made to individual dairies on preference to corn silage concepts or grass and alfalfa sources. If forage production yields of specific programmed forages are not realized, then purchased alternative sources of non-forage NDF/NDFd can be substituted. Specific geography may have different primary and secondary forage sources.

The digestibility of starch sources and the effect on the site of propionate production and absorption in the digestive tract has been a major hurdle to overcome in dairy cow nutrition. The rate, extent, and site of starch digestibility is also the nutritional ration tool required to maintain production stability, maintain production peaks within specific stages of lactation, and reduce incidences of sub-clinical acidosis, off-feed conditions, and reducing or eliminating displaced abomasums.

The grain component of the present feeding method is designed to create a consistent source of starch digestibility utilizing dry grain, as opposed to high-moisture corn (HMC) typically harvested at 30-34% moisture content. The common usage of high-moisture corn has added another source of variation to the rumen diet due to the fact that moisture content of starch and starch digestibility are highly related. Because corn grain has a linear and fast dry down mode in the Fall, being successful at harvesting and storing the HMC grain at the optimum moisture targets has become extremely variable. Thus, the starch digestibility profile can become highly inconsistent during the feed out phase adding inconsistency to the ration. The feeding system of this invention uses dry grain (12%-15.5% moisture) as a means to limit this source of variation and, due to its dry kernel characteristics, storage and sourcing options can add more conservation options for processing the grain into specific particle sizes for more leverage and control of site of ruminal digestion. This added invention feature supplies the needed site of digestion of the starch as a ration tool to synergize with the forage spec of the diet to meet the optimum nutritional needs of the ration. Starch digestibility is the amount of starch that disappears in the ruminant digestive tract due to rumen fermentation and intestinal digestion.

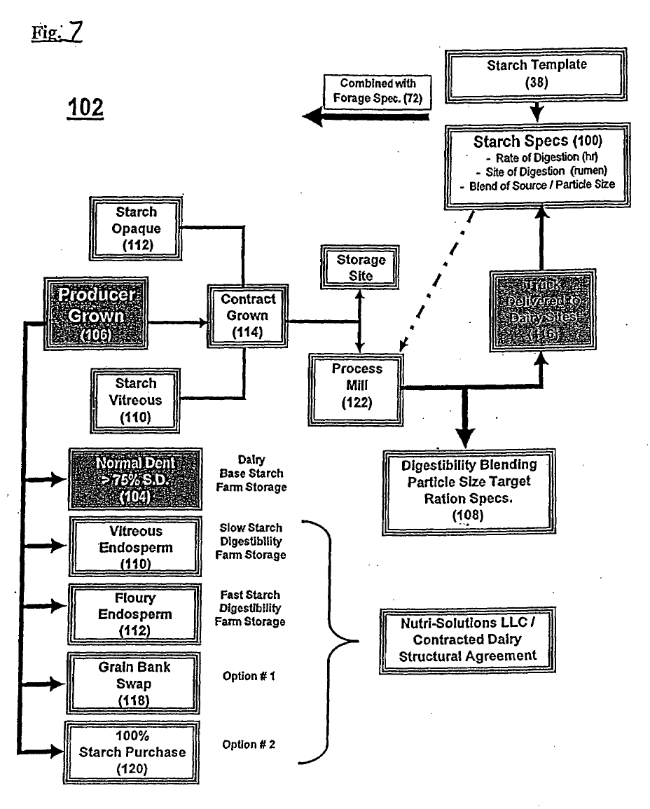

The process 102 for constructing the Starch Template 38 and system for delivering these ingredients for a feed ration is illustrated in FIG. 7. First, the nutritionist prepares the initial starch specifications 100 for the grain ingredients for satisfying the energy and other nutritional needs of the dairy cow. Such starch specifications 100 include the rate of digestion of the starch. The site of digestion of the starch is then targeted and controlled within the rumen and lower tract by use of conservation of the starch by specific particle size. Next, these starch specifications address any shortfall in the energy density of the ration from the actual fiber digestibility and nutritional content of the forage components measured by the real-time characterization method 98 by altering the digestibility characteristics of the starch to match the forage specification requirements 72 for the diet. In this manner, the starch component in the grain ingredient interacts with the NDF and NDFd components of the primary and secondary forage ingredients in order to enhance the animal's performance and health in a synergistic manner. Starch particle size is the mean size of starch particles following a defined physical processing measured typically by dry sieving. Such physical processing can include cracking, rolling, or grinding.

The base source of the grain ingredient can be provided by conventional dent endosperm corn 104. Such dent corn will typically contain a starch content of 68-72%, and a starch digestibility extent of 70% of the starch digested in vitro within seven hours.

The dairy farmer will typically plant and grow its own supply of dent corn grain for this purpose, given the volume required for the feeding rations. Such producer-grown corn grain 106 will be harvested and stored on site at the dairy farm. For smaller dairy farms or residual needs by larger dairy farms, the normal dent corn 104 can be purchased from a third-party supplier. This normal dent genetic base source must come from a screened and identified approved list of genetics that have a starch digestibility history of greater than 75%. A third-party supplier via the feed delivery system 230 of the present invention will provide such a list of approved hybrids to the dairy farm customer. The dairy farm can plant such seed to harvest its own base grain source, or purchase from a supplier such grain produced from such approved hybrids.

The rate of digestion of the starch component within the feed grain ingredient is altered by blending 108 with the dent corn grain 104 vitreous endosperm corn 110 and/or floury endosperm corn 112. In this manner, the targeted starch digestibility is achieved. Vitreous starch is starch that is tightly compacted and held in a complete protein matrix. Floury starch is starch granules that are held in an incomplete protein matrix. Dent corn has an approximately equal ratio of vitreous and flour starch.

The vitreous endosperm starch corn 110 should typically exhibit a starch digestibility rate of approximately 45-55% of the starch digested within seven hours. Such vitreous endosperm starch corn 110 can be supplied by corn hybrids containing the flint germplasm gene, a starch content of 68-72%, and otherwise elite agronomic characteristics. When blended with the dent endosperm corn grain 104, the vitreous endosperm starch corn 110 will slow down the digestibility rate of the starch component of the grain in order to achieve the starch digestibility target of the starch specification 100.

The floury endosperm starch corn 112 should typically exhibit a starch digestibility rate of approximately 80-90% of the starch digested within seven hours. Such floury endosperm starch corn 112 can be supplied by corn hybrids containing the opaque germplasm gene, a starch content of 68-72%, and otherwise elite agronomic characteristics. When blended with the dent endosperm corn grain 104, the floury endosperm starch corn 112 will speed up the digestibility rate of the starch component of the grain in order to achieve the starch digestibility target of starch specification 100.

Equipped with such floury and vitreous endosperm starch “bookends” 110 and 112, the nutritionist can readily blend one or both of the bookends with the dent endosperm corn base 104 during the blending step 108 in order to produce a targeted level of starch digestibility from the grain ingredient that synergistically interacts with the forage ingredients in the feeding ration in order to enhance production and health of the dairy cow that consumes the ration. This rate of starch digestibility might be classified by numbers, as illustrated in Table 3. For instance, a “1” might represent 50%, while “5”, “6”, and “9” might represent 70%, 75%, and 90%, respectively.

TABLE 3
% Starch Digestibility
7 hr. In Vitro Digestibility

| Level | % | Code |
|---|---|---|
| Bookend Slow | 45% | |
| | 50% | 1 |
| | 55% | 2 |
| Low | 60% | 3 |
| | 65% | 4 |
| Medium | 70% | 5 |
| | 75% | 6 |
| High | 80% | 7 |
| | 85% | 8 |
| | 90% | 9 |
| Bookend Fast | 95% | |

The dairy farmer may grow and harvest its own set of vitreous and floury endosperm bookends in order to satisfy its feeding requirements within the contract guidelines of the feed delivery system. However, this entails growing and harvesting three different types of corn grain (four or more counting the primary forage component) on the farm which can be time-consuming, capital-intensive, and risky due to variable weather conditions. Moreover, the floury and vitreous endosperm bookends 110 and 112 must be identity preserved so that they do not become co-mingled with each other or the dent endosperm grain 104, and therefore lose their specialty characteristics.

Therefore, it may be more convenient for the dairy farm to contract with a thirty-party grower 114 for the production and identity-preserved segmentation of these bookends. Such contract-grown vitreous and floury endosperm bookends can be delivered by truck 116 to the dairy farm in advance of the need for these grain blending components. This sourcing of third-party starch ingredients is an integral part of the system of the present invention.

Other potential options for the dairy farm include a grain bank swap 118 instituted by a company that produces the vitreous and floury endosperm bookends 110, and 112 whereby the dairy farm trades some of the base corn grain that it produced for the bookend materials at a predetermined or negotiated rate of exchange. The operator of the grain bank swap 118 can then trade or sell the swapped base dent corn grain to another dairy farm in need. The dairy farm could also simply purchase 100% of its grain needs 120 from a third party. This sourcing of third-party starch ingredients is an integral part of the feed delivery system of the present invention.

In an alternative embodiment of the starch component of this invention, the dairy farmer or nutritionist may choose simply to use vitreous endosperm grain 110 or floury endosperm grain 112 (whichever provides an IVSD value closer to what is set forth within the starch specification) and blend the other endosperm grain type to achieve the desired IVSD target, or else use particle size alone to adjust the IVSD value of the floury or vitreous endosperm starch grain. This presumes an adequate supply of the starch bookend materials, but it will eliminate the need to produce, store, and segregate the normal dent material 104. In still another alternative embodiment, the starch component may simply comprise a normal dent corn hybrid that has been screened and segmented for its above-average starch digestibility. A mixture of normal dent hybrids may also be successfully screened and segmented for such above-average starch digestibility.

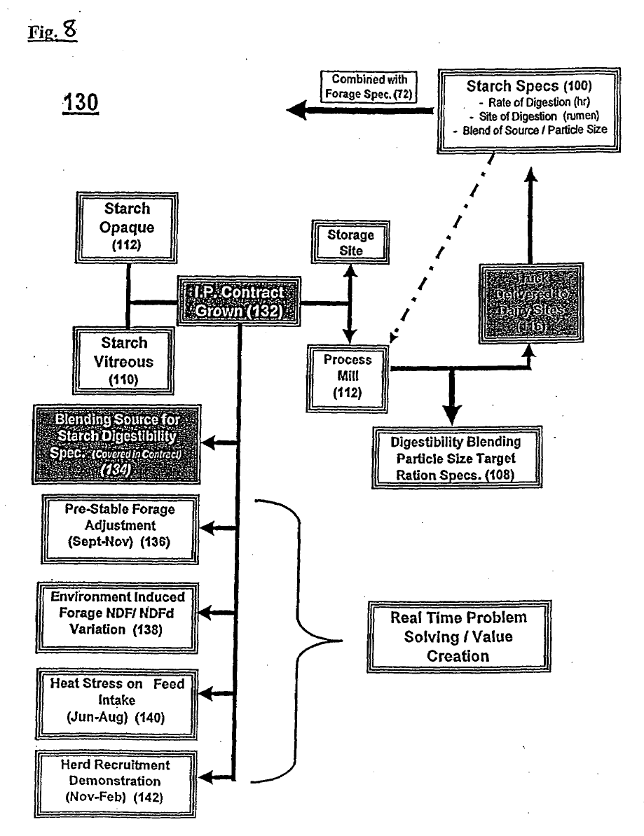

As illustrated in FIG. 8 wherein like elements in FIG. 6 are numbered the same for ease of understanding, this “starch identity preserve system” 130 can solve a number of potential problems for the dairy farm. For example, the dairy farm could contract with a third-party supplier 132 on an identity-preserved basis for a pre-blended source of grain 134 satisfying starch specified digestibility criteria. Similarly, in the Fall, all new crop forage inventories produced on the farm undergo a fermentation process. This fermentation timeline starts from Day Zero at harvest and undergoes two stages of fermentation: respiration (aerobic, oxygen removal) and the actual fermentation (anaerobic) phase. The level of starch digestibility of the grain portion of the silage improves as the fermentation process proceeds. It usually takes the first 90-120 days of the fermentation cycle for the starch fraction of the silage to become fully available, and for the corn silage forage to become fully stable, thereby making the forage energy density inconsistent or “unstable” due to lower access to starch digestibility within the forage. Thus, the dairy farm could contract with the third-party supplier for delivery of a starch source with a specific digestibility and particle size profile 136 during the fermentation period from September-December time period. This starch would supplement the ration with enhanced starch digestibility that is deficient in the pre-stable forage to meet the energy requirements of the stage of production being fed, maintain production stability, and limit the loss of milk production during this feeding period.

The NDF digestibility of forage can be directly impacted by environmental variations like rainfall patterns, cool temperatures, droughts, and high temperatures during the growing season. The dairy farm can contract with the third-party supplier for delivery of starch grain 138 with modified grain blend to offset the environmental effect on fiber (NDF) content and fiber digestibility (NDFd) in order to maintain the stability of milk production. Hot Summer temperatures can also cause cows to consume less dry matter intake. The dairy farm can obtain from the third-party supplier a modified grain blend 140 containing floury endosperm starch with a particle size in the consistency of powder for increased starch digestibility. The third-party supplier might also arrange with dairy farms to supply grain during November-February on a demonstration basis 142 in order to provide a proof of concept of the feeding method and system of the present invention in advance of the next cropping/feeding cycle, and to encourage the farms to sign contracts for enrollment in the system.

The second element of the starch component is to apply conservation methods to produce a specific particle size for the blended starch target comprising the base grain 104, vitreous endosperm starch 110, and floury endosperm starch 112 through processing the starch by cracking, rolling, or grinding the starch through a process mill 122. The net result is to fine tune the degradation properties of the starch even further to alter the rate and site of ruminal digestion of the starch. Such particle size for the grain components might be classified by a letter designation, as shown in Table 4. For example, particle size “A” might be cracked, while particle sizes “C” and “E” might be medium rolled and powder, respectively. In this manner, the nutritionist for a dairy farm could call the grain bank swap 118 or specialty grain producer 116 and ask for a supply of “6C” starch, and receive a load of blended grain containing 75% starch digestibility and a medium rolled particle size by truck within an agreed time frame.

TABLE 4
Starch Particle Size
Millimeter Through Dry Sieve

| Level | Particle Size | | Code |
|---|---|---|---|
| Cracked | >3.0 | mm | A |
| Course/Rolled | 2.0 ≦ x ≦ 3.0 | mm | B |
| Medium Rolled | 1.0 ≦ x < 2.0 | mm | C |
| Fine Rolled | 0.5 ≦ x < 1.0 | mm | D |
| Powder | <0.5 | mm | E |

The third element of the starch component, if needed, is to correct in real time the ongoing changes in feeding environment, variable forages, and changes in feeding strategies by changing the rate of digestibility and the particle size on the go by trucking in the targeted starch to the dairy from off site supplemental storage. This allows for real-time correction of unforeseen elements that have added in sources of variation, a short-term production need, or short fall of on-farm produced starch sources for blending to enhance performance of a specific production group.

The “Ration Fermentability Index” (“RFI”) tool 220 of FIG. 3 constitutes a series of interrelated calculations that evaluate the nutritional effectiveness of the feed ration, and its ability to safely deliver nutritional value to the dairy cow for the pertinent production stage. First, it takes into account the total digestibility of the feed ration, compiling the pounds of digestible fiber contributed by the forage source and the pounds of digestible starch contributed by the grain and forage sources. A range should be specified for this total digestibility within the Nutritional Template 32 for each stage of production of the cows. By checking the NDFd and IVSD values of the various forage and grain starch ingredients used within the feed ration using the real-time characterization tool 98 on a periodic basis, and plugging these values into the total digestibility equation, the nutritionist can determine whether the GELT Effect has caused one or more of the feed ingredients to provide too much or too little fiber and starch digestibility to the cow that is fed the feed ration.

Next, the NDFd and IVSD values should be measured for the individual feed components. This data will tell the nutritionist which specific ingredients are contributing the fiber and starch digestibility to the feed ration. For different stages of production, the cow may need different levels of NDFd and IVSD.

Next, the relative ruminal starch (“RAS”) and ruminal bypass starch (“RBS”) values should be calculated to see whether the RAS/RBS ratio is within the range specified within the Nutritional Template. By controlling the RAS/RBS ratio, maximum healthy milk production may be obtained.

Finally, by comparing the total ration digestibility, individual component digestibilities, and dry matter, NDF, NDFd, IVSD, and RAS/RBS ratio values for the total diet against the corresponding values specified within the Nutritional Template, the nutritionist can quickly and accurately determine in real time through this RFI tool 220 whether the feed ration ingredients need to be adjusted to bring the diet into conformity with the specifications during the production stage. Not only can this lead to enhanced milk production and stability, but also it can save the cows from serious health issues suffered from feed rations that are too “hot” because individual feed components exhibited unexpectedly high digestibility.

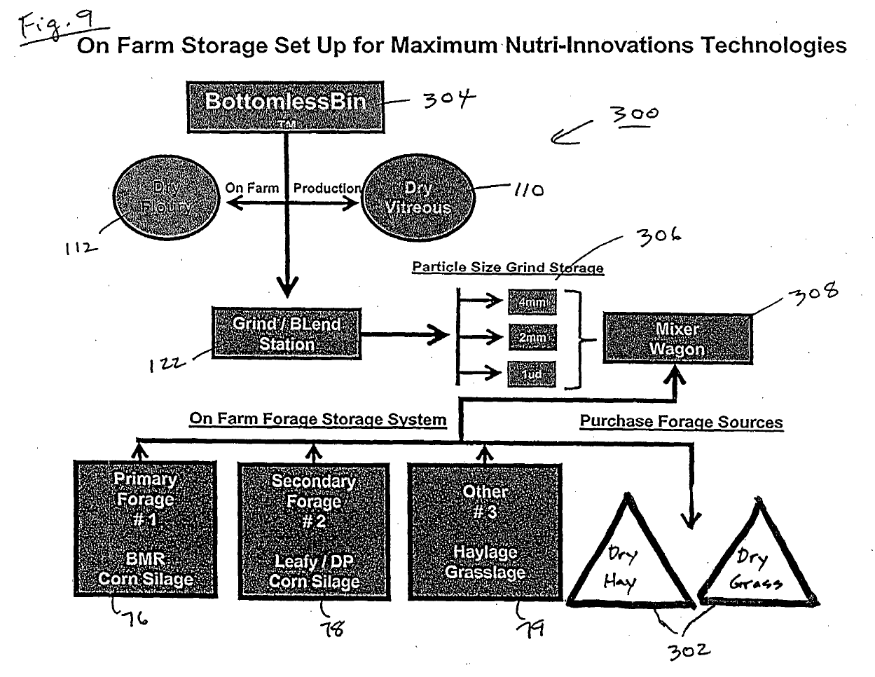

FIG. 9 shows an on-farm storage system 300 implemented by the dairy farm for practicing the feed method. The primary forage 76, secondary forage 78, and any other forage material 79 for the feed ration, such as haylage or grasslage, can be grown on the dairy farm and stored in suitable water and air-tight bins to maintain their fresh nutritional contents prior to their usage. Likewise, the dry floury endosperm starch grain 112 and dry vitreous endosperm starch grain 110 components may be grown by the dairy farm and stored in separate bins prior to usage.

If the dairy farm runs out of forage materials, it can purchase them from a selected source 302 made available by the feed delivery system of the present invention. Similarly, if the dairy farm runs out of the starch materials (110, 112), or does not want to assume the responsibility for growing, harvesting, and storing them, it can source some or all of its starch requirements from the “Bottomless Bin” 304 service of the feed delivery system 230. The two sources of floury and vitreous endosperm starch grain will need to be contract grown and segmented to supply a continual source of each grain to the contracted dairy farm. To maintain a continual access to these endosperm starch sources requires access to this segmented grain. A premium per bushel will be assigned to the delivered grain purchased at daily market rates and delivered to the dairy farm by a starch sourcing partner of the feed delivery system. Total contract grain production in the Bottomless Bin system is determined and forecasted each year by the feed delivery system, based upon the total contracted numbers of cows (subtracting projected on-farm production), and historical usage history by the dairy farm.

The resulting starch materials are blended together (122) and ground to an appropriate particle size (306) to control the level of starch digestibility and site of digestion within the cow rumen. Finally, the forage components (76, 78, 79, 302) and starch components (110, 112, 304) are mixed together in mixer wagon 308 in accordance with the Nutritional Template and Feed Template to produce the feed ration that is fed to the dairy cows.

The feed delivery system of this invention includes a software interface platform to create a computerized linkage of the Nutritional and Feeding Template information to download these ration feeding values into a feed company's or nutritionist's linear programmed Ration Formulation Software for ease of application of the feeding method. Using available Software programs like “CPM Dairy Software” and his or her knowledge and experience in animal nutrition, the nutritionist can convert the Nutritional Template 32 into a Feeding Composition Template 40.

The feed delivery system of this invention also supplies a Cropping Rotation Calculator software to interface with the Nutritional and Feeding Templates to capture all of the farm inputs necessary to design a Ration/Rotation production plan that will calculate the amount of tons and bushels of the forages and grains necessary for a yearly feed out period utilizing the invention system for the purpose of setting up the acre allocation, seed genetic sources from preferred lists, and the delivery of the seed genetic component that will be supplied by the third-party nutrition platform within a contract structure.

Typical real-time characterization values for NDF, NDFd, Lignin, % Starch, Protein and calculated energy values of the existing inventory of forages being fed and/or carried over into the next production year and the new crop forages being grown for the next production year are shown in Table 5. The identity-preserved grain production and the home grown base starch program requires accurate validation of the rate and extent of starch digestibility.

TABLE 5
On Farm Forages
Current Inventory/New Crop

| Forage | % Dry Matter | % NDF | NDFd | Lignified | % Starch | % WP | Mcal/lb | % CP |
|---|---|---|---|---|---|---|---|---|
| Source | Content | % DM | % of NDF | NDF | % DM | IVTD | Net Energy Lactation | Crude Protein |
| Dual-Purpose CS | 30%-35% | 32%-38% | 43%-50% | <6.0 | 30%-36% | 78%-84% | 0.70-0.73 | 6%-7.5% |
| Leafy CS | 30%-35% | 48%-55% | 50%-54% | <5.5 | 22%-26% | 76%-80% | 0.65-0.70 | 6%-7.5% |
| BMR CS | 28%-32% | 32%-38% | 58%-64% | <4.5 | 30%-38% | 84%-88% | 0.73-0.75 | 6%-7.5% |
| Alfalfa Haylage | 50%-60% | 40%-42% | 48%-52% | <15.0 | N/A | 78%-82% | 0.65-070 | 18%-22% |
| Alfalfa Dry Hay | 12%-15% | 42%-44% | 48%-52% | <15.0 | N/A | 78%-82% | 0.65-0.70 | 18%-22% |
| Grass Haylage | 45%-55% | 50%-55% | 48%-52% | <8.0 | N/A | 72%-76% | 0.60-0.65 | 14%-18% |
| Grass Dry Bale | 12%-15% | 50%-55% | 48%-52% | <8.0 | N/A | 72%-76% | 0.60-0.65 | 14%-18% |
| Alfalfa/Grass Mix | 12%-15% | 45%-50% | 44%-48% | <12.0 | N/A | 75%-80% | 0.63-0.68 | 16%-20% |

Lignified NDF = % Lignin/% NDF × 100
IVTD & NDFd = 30 Hr. In Vitro Fermentation
NEI values from tabulated compositional data in Hutjens (1998).

On Farm/Identity Preserved Grains
Current Inventory/New Crop

Corn Grain Characteristics

| | % Oil | % Protein | % Starch | IVSD |
|---|---|---|---|---|
| Grain Source | % DM | % DM | % DM | 7 hr In Vitro |
| On Farm Base Grain #1 | 2.8%-3.8% | 6.5%-9.5% | 68%-76% | 60%-78% |
| On Farm Base Grain #2 | 2.8%-3.8% | 6.5%-9.5% | 68%-76% | 60%-78% |
| On Farm Base Grain #3 | 2.8%-3.8% | 6.5%-9.5% | 68%-76% | 60%-78% |
| Fast Digestibility I.P. Source #1 | 2.8%-3.8% | 6.5%-9.5% | 68%-76% | 85%-95% |
| Fast Digestibility I.P. Source #2 | 2.8%-3.8% | 6.5%-9.5% | 68%-76% | 85%-95% |
| Slow Digestibility I.P. Source #1 | 2.8%-3.8% | 6.5%-9.5% | 68%-76% | 45%-55% |
| Slow Digestibility I.P. Source #2 | 2.8%-3.8% | 6.5%-9.5% | 68%-76% | 45%-55% |

IVSD = In Vitro Starch Digestibility (7 hr.)

The timing of the real-time characterization of these feedstuffs will typically take place at the time of harvesting and segmentation which normally occurs during the months of September and October of each growing season. A second characterization of these feed stuffs should be implemented at the time of ration formulation and fed in real time. Ongoing forage sampling on a month or bimonthly basis will be required to limit the impact of natural variation from storage sources impacted by field variation, stage of harvest, harvest management & the fermentation process.

The information resulting from this real-time characterization of the forage and grain components for the feed ration is used to help prepare the Nutritional Template. The synergy of the primary and secondary forage sources, forage specifications, and starch specifications need to be taken into account for the rations for each production group of dairy cows, as discussed above. But the likely characteristics of the forage and grain ingredients need also to be considered when deciding which forage ingredients, e.g., to use for the Nutritional Template. In addition, consideration should be given to how many pounds of milk production the dairy farm seeks from its cows, balancing the sometimes conflicting properties of milk production stability, milk production, and animal health, and the number of cows that need to be fed.

In order to formulate the Nutritional Template 32, therefore, first, the Forage Template 36 is created. Second, the fermentability of the forage ingredients is evaluated using the real-time characterization tool 226 and RFI 220. Third, the Starch Template 38 is added to compliment the Forage Template ingredient values. Only in this manner can the fiber-starch synergy of the feed ration be captured.

The resulting Nutritional Template will then be used to produce a Feeding Template by means of available feed formulation software programs, etc. This Feeding Template will spell out the total volume of forage, starch, and NFFS ingredients required by the dairy farm for feeding its cows across the various production groups during the next year. In order to prepare for such feed ingredient requirements, the dairy farm should implement a farm production plan that determines the number of acres of seed that need to be planted for the primary and secondary forage and grain components, or alternatively what portion of the grain or forage ingredients will be sourced from third-party suppliers. Planting and harvesting the forage crops and grain, and contracting for any required third-party supplies of grain and other feed components will ensure that the dairy farm has a reliable and timely supply of ingredients required for the feed rations produced in accordance with the Feeding Template for the dairy cows.

Exemplary feed compositions utilizing the feed method associated with the feed delivery system of the present invention are disclosed in Applicant's U.S. Ser. No. 11/494,312 filed on Jul. 27, 2006, and Applicant's co-pending application entitled “Method and Feed for Enhancing Ruminant Animal Nutrition” filed on even date herewith, both of which are incorporated hereby in their entirety.

The feeding method of the present invention permits dairy farms to substitute non-forage fiber sources (“NFFS”) for a portion of the forage sources set forth in Table. 6. These NFFS substitutes include beet pulp, citrus pulp, soy hulls, corn gluten feed (wet), corn gluten feed (dry), distillers grains (wet or dry), brewers grains (wet or dry), and cottonseed hulls. They are set forth more specifically in Table 6, listing the maximum substitution amount for each NFFS as a percentage of forage NDF by production group. Use of such NFFS sources provides additional flexibility to the dairy farm and potential reductions in cost for feed ration formulations.

TABLE 6

| Feeding Strategy | Non-Forage NDF as a % of Forage NDF | | | | | | | |
|---|---|---|---|---|---|---|---|---|
| Production | Beet | Citris | Soy | Corn Gluten | Corn Gluten | Distillers | Brewers | Cottenseed |
| Group | Pulp | Pulp | Hulls | Feed (wet) | Feed (dry) | Grains (wet/dry) | Grains (wet/dry) | Hulls |
| Fresh Cows | <10% | <9% | <10% | <25% | <20% | <15% | <15% | <8% |
| Early Lactation | <15% | <9% | <15% | <25% | <20% | <15% | <15% | <8% |
| Mid Lactation | <15% | <9% | <15% | <25% | <20% | <15% | <15% | <8% |
| Late Lactation | <15% | <9% | <15% | <25% | <20% | <15% | <15% | <8% |
| Far Off Dry | <15% | <9% | <15% | <25% | <20% | <15% | <15% | <8% |
| Close Up Dry | <15% | <9% | <15% | <25% | <20% | <15% | <15% | <8% |
| Heifers | <15% | <9% | <15% | <25% | <20% | <15% | <15% | <8% |

Non-forage NDF and NDFd sources such as best pulp and soy hills can be used in substitution for forages when expected forage inventories from forage sources planted on the farm become deficient due to poor yield environments, access to off-farm forage purchases are limited or not price competitive, or purchase opportunities for these NFFS become price competitive to normal forage sources.

Although there may be an optimum silage concept for maximizing profitability for the different cow production groups, not every dairy farm will be capable of growing or otherwise sourcing and segmenting all three of these corn silage materials within their dairy structure or cropping radius. Some dairies may not have the land or storage system required to implement the required segmentation set up to maintain these different silage sources. Therefore, the feeding method of this invention is designed to enable the farm cropping team to use the primary silage source or sources that best suits its operation. However, BMR corn silage will need to be a forage component of minimum acreage/tonnage to maximize return on investment for the system.

The farm crop managers and its nutritionist will therefore need to audit its current farm production, dairy cow production, and the current feeding strategies. This audit will incorporate the Forage Template 36 requirements and dairy production goals in order to design the forage module that will be used. As part of that equation, a decision can be made concerning which silage sources need to be planted on the farm to be grown by the dairy producer 94, itself, versus which silage sources can be contract grown 96 or otherwise purchased from third parties.

In an important aspect of the feed method of the present invention, the milk production levels of a substantial number of cows, preferably all of the cows, within the production stage should be monitored, pursuant to the cow re-penning strategy tool 222 shown in FIG. 3. A dairy cow re-balancing system for pen grouping strategies plots the effect on days in milk of during the lactation cycle, the cow's reproduction capability, and milk production and milk components response by individual cows upon a change in diet composition. Incorporating the test day data forwarded by the dairy farm and the previous baseline test date, the cows within a pen can be plotted to determine the production effect of the diet by cow. Cows that drop from the previous baseline are identified and targeted for pen movement to the proper diet. The net effect of this system is to measure ration production efficiency, identify miss-grouped cows within a pen, and supply an accurate pen re-balancing strategy to maximize productivity and profitability while maintaining overall herd health.

This re-penning strategy enables high milk producer cows to be separated from low producer cows during the lactation cycle. The feed diet can be continued for such high-producer cows, which will enable them to achieve high milk production values without being impeded by the low-producer cows. Meanwhile, the nutritionist can reformulate the feed diet for the low-producer cows that have been re-penned within a separate pen in order to enhance the days in milk and milk production levels and components for such cows, and address any herd health issues that were responsible for retarding their milk production. This represents a significant departure from conventional cow feeding practices in which only milk production yield data for an entire cow production group is monitored, and all of the cows are treated to the same ration.

As shown more fully in FIG. 9, data identifying the current pen grouping of each cow and the milk production level, milk components, etc. for each such cow are entered into a computer 150 maintained by the dairy farmer or nutritionist at the milking parlor. This data is then transferred on a periodic basis (e.g., weekly or monthly) to a third-party nutritionist computer 152 via a data transfer link such as that provided by the Dairy Herd Improvement Association (“DHIA”) or the Dairy-Comp 305 system available within the industry. Using proprietary software, this nutritionist can translate the raw milk production data 154 for the cows in the current production group into a simple, easy to understand graph 156 in which each cow's previous milk yield (baseline) is plotted against that cow's increase or decrease in milk yield. The resulting distribution of cows above and below the baseline 158 allows then to be separated into a high-producer group (Pen A) 160 and low-producer group (Pen B) 162. The third-party nutritionist can transmit back to the dairy farm a responsive data set 164, a regrouping strategy (Pen A vs. Pen B) for the cows, a new Nutritional Template for the Pen A high-producer cows to further liberate their milk production and stability potential, and a new Nutritional Template for the Pen B low producer cows to bring them at least back to their baseline for milk production and address any hard health issues that may have contributed to their depressed milk yield. Thus, using this pen regrouping tool, the Nutritional Templates for feeding cows within a production cycle change dynamically in response to their real-time needs.

Mention has been made several times during this application to real-time characterization tool 226 shown in FIG. 3. It is described more fully in issued U.S. Pat. No. 7,174,672 issued to Applicant, co-pending U.S. Ser. No. 11/584,767 filed by Applicant on Oct. 20, 2006, and the co-pending application entitled “System for Real-Time Characterization of Ruminant Feed Components” filed by Applicant on even date herewith, all of which are hereby incorporated by reference in their entirety. The current inventory of forage and grain ingredients on farm, as well as any new forage and grain crops that may be planted by the dairy farm need to be characterized in real time. A representative sample of each field is obtained and scanned using NIRS at the wavelengths required by a corresponding prediction equation previously developed. Fiber digestion characteristics of the plants in each field are predicted using this equation. Moreover, the starch digestibility characteristics of the starch and forage sources are also predicted using this set of equations. The starch characterisitics are then used to determine the ruminal available starch (RAS) and ruminal by-pass starch (RBS) of the multiple sources in the feed ration. Furthermore, prediction equations can predict the fiber or starch digestibility characteristics of the forage or starch component for different particle sizes. Combining these starch values with the fiber digestibility (NDFd) of both the primary and secondary forage sources in the ration enables the calculation of the RFI for use in feed programming to build accurate and safe diets by stage of production in the dairy cows. Of significant value is the fact that an “as-is” wet crop sample can be evaluated in real time without the need to dry and grind it as conventional laboratory NIRS instruments commonly require.

This NIRS analysis is done in a laboratory or in the field using a portable NIRS instrument. It is desirable that the methods to measure these traits are relatively quick, e.g., in real time. Real time refers to obtaining the starch and fiber digestibility results within 48 hours from when the samples are obtained and tested, and more preferably within 24 hours from when the samples are obtained and tested.

Briefly, the NIRS method includes obtaining a set of crop plant samples with known characteristic such as starch and fiber degradability. These characteristics are measured according to the IVSD and NDFd measurement methods described above. Other starch and NDFd measurement methods known in the art can be used as well. These crop plant samples are scanned in the near infrared spectrum. Reflectance in the near-infrared spectrum is then recorded. A prediction equation for each trait is developed by regressing the known measured characteristics on reflectance across wavelengths for each set of samples.

For each trait, the prediction equation is validated by predicting the characteristic of interest for an independent set of samples. According to the present invention, the measured characteristics of interest are: In grain, % IVSD in the grain, corn silage, HMC or dry corn, and particle size. These values reflect the rate and extent of ruminal starch digestibility at a specified digestion period, usually 7 hours. IVSD should be measured at different particle sizes, such as 6 mm, 4 mm, 2 mm, 2 UD, and 1 UD. For the forage sources, characteristics of interest include dry matter content, NDF, fiber digestibility (NDFd), lignin content, in vitro whole plant digestibility (IVTD), corn silage starch digestibility (IVSD-CS), corn silage particle size at different lengths of chop (peNDF) and conservation processing methods. Finally, separate equations should be developed for different crop species to be used with the feed rations, including dual-purpose corn, leafy corn, BMR corn, grass (silage/dry), alfalfa (silage/dry), and BMR forage sorghum.

Near-infrared reflectance spectroscopy (NIRS) is a nondestructive, instrumental method for rapid, accurate, and precise determination of the chemical composition of forages and feedstuffs. NIRS is an accepted technology for feed and forage analysis, and industrial uses. NIRS has several distinct advantages: the speed of analysis, non-destructive analysis of the sample, simplicity of sample preparation, and several analyses can be completed with one sample. Since NIRS analysis is relatively simple to perform, operator-induced errors are reduced.

To measure starch degradability in vitro, a set of crop plant samples comprising a number of genetically different crop plants are analyzed for starch concentration before and after incubation in media inoculated with rumen fluid containing ruminal microbes for various lengths of times. Starch degradability is calculated as the amount of starch that disappeared as a percent of the total starch in the sample for each time point of interest. Starch concentration can be determined by analysis of glucose concentration before and after hydrolysis using commercially available analysis kits. Glucose concentration may be determined enzymatically using glucose oxidase method or by high performance liquid chromatography. For general methods of measuring feed digestibility in vitro see Goering and Van Soest (1970). An alternative method is to incubate feed samples in porous bags in the rumen of cattle or sheep. (Philippeau and Michalet—Doreau, 1997).

To measure fiber digestibility in vitro, dried plant tissues were ground with a Wiley® mill to pass a 1 mm screen. In vitro true digestibility (IVTD) and in vitro neutral detergent fiber digestibility was determined using 0.5 g samples using a modification of the method of Goering and Van Soest (1970) with an incubation time representing the rumen residence time of the animal of interest such as 30 h. Undigested IVTD residue was subjected to the neutral detergent fiber (NDF) procedure (Goering and Van Soest, 1970). A modification of the NDF procedure was the treatment of all samples with 0.1 ml of alpha-amylase during refluxing and again during sample filtration, as described by Mertens (1991). Alpha-amylase was assayed for activity prior to use, according to Mertens (1991). NDF digestibility (dNDF) for each sample was computed by the equation: 100*[(NDF−(100−IVTD))/NDF].

Accuracy of the laboratory values for defining the forage quality parameters of the forage and the starch digestibility profile of the grains is paramount to value creation from the invention. To maximize the synergy of the forage and grain specs, the accuracy of the forage template to capture the forage synergy of the forage sources, and to properly develop the Feeding Template requires accurate characterization. It is therefore important to use only analytical laboratories that are certified by the National Forage Testing Association (NFTA) to maintain the accuracy and consistency of the characterization process.

The invention requires an approved certified lab to characterize both forage and grains to establish a historic baseline for each characterized trait. This baseline can be used to determine the hybrid genetic effect and the environmental effect within a given growing season on the forage quality traits and the potential feeding value of both forages and grains used in the Nutritional Template. Accurate adjustments can then be made to the Nutritional Template to maintain the accuracy of the resulting Feeding Template for each stage of dairy cow production.

The same Real Time Characterization process is used in the genetic development of superior forage and grain genetics necessary for the feed ingredients. Real-time characterization measures the direction, progress and level of trait enhancement of the breeding process. It also is used as a database development tool for screening and identifying the top performing genetics for invention application. Moreover, this tool can be used to measure quality traits other than NDFd and IVSD, such as oil content, crude protein, and NDF.

The above specification, drawings, and data provide a complete description of the feeding method and resulting feed compositions of the present invention. Since many embodiments of the invention can be made without departing from the spirit and scope of the invention, the invention resides in the claims hereinafter appended.

What is claimed is:

1. A feed delivery system for a dairy farm for enhancing milk production stability in a dairy cow across a multiple-stage lactation cycle resulting in a net increase of total milk production and milk components per lactation, comprising the steps of:
(a) providing to the dairy farm a list of approved hybrids or varieties for creating a ration forage composition with specific NDF and NDFd levels selected from the group consisting of brown midrib corn silage, dual-purpose corn silage, leafy corn silage, and grass for use as a primary forage source;
(b) providing to the dairy farm a list of approved hybrids or varieties that compliment the primary forage source by contributing a specific level of forage particle size and crude protein from the forage, such varieties being selected from the group consisting of dual-purpose corn silage, alfalfa haylage, alfalfa hay, dry grass, grass silage, alfalfa/grass mix, and forage sorghum for use as a secondary forage source;
(c) providing to the dairy farm a list of approved floury endosperm starch and/or vitreous endosperm starch corn hybrids to use as grain to achieve in vitro starch digestibility level for providing an appropriate level and site of digestion of such starch and creation of optimum propionic acid to the cow upon digestion of the grain;
(d) providing a nutritional template specification to the dairy farm specifying the relative amounts of primary forage, secondary forage, corn grain, and the starch digestibility and particle size for the blended corn grain for a feed ration for the dairy cow for its stage of lactation; and
(e) enabling a nutritionist to determine the amounts of primary forage, secondary forage, dent germplasm base grain, floury endosperm starch and/or vitreous endosperm starch necessary for combination into the feed ration so that when the feed ration is consumed by the cow, the amounts will optimize the ruminal environment inside the cow for optimum feed intake level and site of starch degradation, and energy intake for utilization to producing the enhanced milk production property.

2. The feed delivery system according to claim 1 further comprising providing the dairy farm at least a portion of its required floury endosperm starch grain for the feed ration.

3. The feed delivery system according to claim 1 further comprising providing the dairy farm at least a portion of its required vitreous endosperm starch grain for the feed ration.

4. The feed delivery system according to claim 1 further comprising providing the dairy farm at least a portion of its required primary forage for the feed ration.

5. The feed delivery system according to claim 1 further comprising providing the dairy farm at least a portion of its required secondary forage for the feed ration.

6. The feed delivery system according to claim 1 further comprising providing the dairy farm at least a portion of its required blended floury and/or vitreous endosperm starch grain that satisfies the starch digestibility and particle size requirements for the feed ration.

7. The feed delivery system according to claim 1, wherein the primary forage or secondary forage is brown midrib corn silage.

8. The feed delivery system according to claim 1 further comprising providing the dairy farm a software interface for incorporating the nutritional template data into the dairy farm's feed formulation software to construct a feed template.

9. The feed delivery system according to claim 1 further comprising providing the dairy farm means for automatically calculating the total volume of forage or starch ingredient needs based upon the nutritional template and feed template prior to the dairy farm planting seed for such forage or starch ingredient, or contracting to source it from a third party.

10. The feed delivery system according to claim 1 further comprising providing the dairy farm a real-time characterization of at least one forage or starch ingredient for use in more accurately formulating the feed ration.

11. The feed delivery system according to claim 1 further comprising providing the dairy farm a real-time characterization of at least one forage or starch ingredient during a cow production stage to enable the calculation of a ration fermentability index value for the resulting feed ration prepared in accordance with the nutritional template to determine whether the nutritional template should be reformulated.

12. The feed delivery system according to claim 1 further comprising providing the dairy farm a revised pen allocation for at least one cow and a reformulated nutritional template for such cow in response to a comparison made of the days-in-milk or milk production level of the cow at a first point in time versus a second point in time during the production stage.

13. A feed delivery system for a dairy farm for enhancing milk production stability in a dairy cow across a multiple-stage lactation cycle resulting in a net increase of total milk production and milk components per lactation, comprising the steps of providing the dairy farm a revised pen allocation for at least one cow and a reformulated nutritional template for such cow in response to a comparison made of the days-in-milk or milk production level of the cow at a first point in time versus a second point in time during the production stage.
